(19) United States
(12) Patent Application Publication
(10) Pub. No.: US 2026/0360270 A1
(43) Pub. Date: Nov. 12, 2026

(54) SYSTEMS AND METHODS FOR GENERATING AND ASSIGNING AUTOMATED TRAINING ACCREDITATION ACROSS REMOTE DEVICES

(71) Applicant: TaskFlowManager, LLC, Greenville, SC (US)

(72) Inventor: Jason Staiger, Greenville, SC (US)

(73) Assignee: TaskFlowManager, LLC, Greenville, SC (US)

(21) Appl. No.: 19/669,649

(22) Filed: May 6, 2026

Related U.S. Application Data
(60) Provisional application No. 63/803,213, filed on May 9, 2025.

(51) Int. Cl. G09B 7/00; G06F 21/32

(52) U.S. Cl. CPC G09B 7/00; G06F 21/32

(57) ABSTRACT

Systems, methods, and computer program products are provided for generating and assigning automated training accreditation across remote devices. An example method includes determining a training type of a user based on a user profile associated with the user. The training type indicates a type of training to be assigned to the user. The example method also includes determining at least one training module to assign to the user profile based on the training type. The example method further includes causing a rendering of a user interface that includes the at least one training module to a computing device associated with the user. The example method still further includes verifying completion of the at least one training module. The completion of the at least one training module is verified using knowledge verification. The knowledge verification includes completing a knowledge verification quiz relating to the at least one training module.

### CROSS-REFERENCE TO RELATED APPLICATIONS

The present application claims the benefit of and priority to U.S. Provisional Patent Application No. 63/803,213, filed May 9, 2025, and titled "SYSTEMS AND METHODS FOR GENERATING AND ASSIGNING AUTOMATED TRAINING ACCREDITATION ACROSS REMOTE DEVICES," the contents of which is incorporated herein by reference in its entirety for all purposes.

### FIELD

An example embodiment relates generally to systems and methods for generating and assigning training accreditation, and more particularly, to generating and assigning automated training accreditation across remote devices.

### BACKGROUND

Training users for an entity is often completed using word of mouth and paper guidelines established by each entity. However, new users need to be both trained to complete tasks safely and meet certain safety certifications. Currently, training is often only as successful as the person training and different users receive vastly different training. The issue with training is only made more difficult as more users work remotely. As such, currently there is a limitation to the size and scale proper training. Therefore, there exists a need for a system that allows for generating and assigning automated training accreditation across remote devices.

### SUMMARY

The following paragraphs present a summary of various embodiments of the present disclosure and are merely examples of potential embodiments. As such, the summary is not meant to limit the subject matter or variations of various embodiments discussed herein.

In some aspects, the techniques described herein relate to a system for generating and assigning automated training accreditation across remote devices, the system including: at least one non-transitory storage device; and at least one processing device coupled to the at least one non-transitory storage device, wherein the at least one processing device is configured to: determine a training type of a user based on a user profile associated with the user, wherein the training type indicates a type of training to be assigned to the user; determine at least one training module to assign to the user profile based on the training type; cause a rendering of a user interface that includes the at least one training module to a computing device associated with the user; and verify completion of the at least one training module, wherein the completion of the at least one training module is verified using knowledge verification, wherein the knowledge verification includes completing a knowledge verification quiz relating to the at least one training module.

In some aspects, the techniques described herein relate to a system, wherein the training type is based on a job type for the user.

In some aspects, the techniques described herein relate to a system, wherein the at least one processing device is further configured to generate the user profile associated with the user, wherein the user profile indicates the training type for the user.

In some aspects, the techniques described herein relate to a system, wherein the at least one processing device is further configured to verify completion of the at least one training module via a user verification, wherein the user verification includes monitoring the computing device associated with the user for engagement with the at least one training module.

In some aspects, the techniques described herein relate to a system, wherein the user verification is completed via monitoring a user input relating to the at least one training module.

In some aspects, the techniques described herein relate to a system, wherein the user verification is completed via visual verification using a camera connected to the computing device associated with the user.

In some aspects, the techniques described herein relate to a system, wherein the user verification includes receiving at least one of a picture or a video of the user completing the at least one training module.

In some aspects, the techniques described herein relate to a system, wherein the at least one processing device is further configured to verify the user completed the at least one training module based on the at least one of the picture or the video of the user completing the at least one training module.

In some aspects, the techniques described herein relate to a system, wherein the at least one processing device is further configured to generate the at least one training module, wherein the at least one training module is assigned to a training type.

In some aspects, the techniques described herein relate to a system, wherein generating the at least one training module includes converting a training material for viewing via the computing device associated with the user.

In some aspects, the techniques described herein relate to a system, wherein generating the at least one training module includes generating the knowledge verification quiz for each of the at least one training module.

In some aspects, the techniques described herein relate to a system, wherein each training type is associated with a training set, wherein the training set includes the at least one training module to assign to the user based on the training type.

In some aspects, the techniques described herein relate to a system, wherein the at least one processing device is further configured to update the training set for the user based on one or more previously completed training modules, wherein the one or more previously completed training modules are removed from the at least one training module assigned to the user.

In some aspects, the techniques described herein relate to a system, wherein the user interface is rendered as a platform for a user to engage via the computing device associated with the user.

In some aspects, the techniques described herein relate to a system, wherein the at least one training module includes at least one video, wherein the at least one video must be viewed from a start to a finish to verify completion of the at least one training module.

In some aspects, the techniques described herein relate to a system, wherein the knowledge verification quiz is available to complete upon completion of the at least one video.

In some aspects, the techniques described herein relate to a system, wherein the at least one processing device is further configured to generate a training compliance report, wherein the training compliance report indicates a completion status for each of the at least one training module.

In some aspects, the techniques described herein relate to a system, wherein the training compliance report relates to the user and at least one additional user.

In some aspects, the techniques described herein relate to a system, wherein the at least one processing device is further configured to cause a certification to be provided to the user based on the completion of the at least one training module.

In some aspects, the techniques described herein relate to a system, wherein the at least one processing device is further configured to assign a new training module to the user based on the training type of the user; wherein the new training module is assigned upon creation and association with the training type.

In some aspects, the techniques described herein relate to a method of generating and assigning automated training accreditation across remote devices, the method including: determining a training type of a user based on a user profile associated with the user, wherein the training type indicates a type of training to be assigned to the user; determining at least one training module to assign to the user profile based on the training type; causing a rendering of a user interface that includes the at least one training module to a computing device associated with the user; and verifying completion of the at least one training module, wherein the completion of the at least one training module is verified using knowledge verification, wherein the knowledge verification includes completing a knowledge verification quiz relating to the at least one training module.

In some aspects, the techniques described herein relate to a method, wherein the training type is based on a job type for the user.

In some aspects, the techniques described herein relate to a method, further including generating the user profile associated with the user, wherein the user profile indicates the training type for the user.

In some aspects, the techniques described herein relate to a method, further including verifying completion of the at least one training module via a user verification, wherein the user verification includes monitoring the computing device associated with the user for engagement with the at least one training module.

In some aspects, the techniques described herein relate to a method, wherein the user verification is completed via monitoring a user input relating to the at least one training module.

In some aspects, the techniques described herein relate to a method, wherein the user verification is completed via visual verification using a camera connected to the computing device associated with the user.

In some aspects, the techniques described herein relate to a method, wherein the user verification includes receiving at least one of a picture or a video of the user completing the at least one training module.

In some aspects, the techniques described herein relate to a method, further including verifying the user completed the at least one training module based on the at least one of the picture or the video of the user completing the at least one training module.

In some aspects, the techniques described herein relate to a method, further including generating the at least one training module, wherein the at least one training module is assigned to a training type.

In some aspects, the techniques described herein relate to a method, wherein generating the at least one training module includes converting a training material for viewing via the computing device associated with the user.

In some aspects, the techniques described herein relate to a method, wherein generating the at least one training module includes generating the knowledge verification quiz for each of the at least one training module.

In some aspects, the techniques described herein relate to a method, wherein each training type is associated with a training set, wherein the training set includes the at least one training module to assign to the user based on the training type.

In some aspects, the techniques described herein relate to a method, further including updating the training set for the user based on one or more previously completed training modules, wherein the one or more previously completed training modules are removed from the at least one training module assigned to the user.

In some aspects, the techniques described herein relate to a method, wherein the user interface is rendered as a platform for a user to engage via the computing device associated with the user.

In some aspects, the techniques described herein relate to a method, wherein the at least one training module includes at least one video, wherein the at least one video must be viewed from a start to a finish to verify completion of the at least one training module.

In some aspects, the techniques described herein relate to a method, wherein the knowledge verification quiz is available to complete upon completion of the at least one video.

In some aspects, the techniques described herein relate to a method, further including generating a training compliance report, wherein the training compliance report indicates a completion status for each of the at least one training module.

In some aspects, the techniques described herein relate to a method, wherein the training compliance report relates to the user and at least one additional user.

In some aspects, the techniques described herein relate to a method, further including causing a certification to be provided to the user based on the completion of the at least one training module.

In some aspects, the techniques described herein relate to a method, further including assigning a new training module to the user based on the training type of the user; wherein the new training module is assigned upon creation and association with the training type.

In some aspects, the techniques described herein relate to a computer program product for generating and assigning automated training accreditation across remote devices, the computer program product including at least one non-transitory computer-readable medium having one or more computer-readable program code portions embodied therein, the one or more computer-readable program code portions including at least one executable portion configured to: determine a training type of a user based on a user profile associated with the user, wherein the training type indicates a type of training to be assigned to the user; determine at least one training module to assign to the user profile based on the training type; cause a rendering of a user interface that includes the at least one training module to a computing device associated with the user; and verify completion of the at least one training module, wherein the completion of the at least one training module is verified using knowledge verification, wherein the knowledge verification includes completing a knowledge verification quiz relating to the at least one training module.

In some aspects, the techniques described herein relate to a computer program product, wherein the training type is based on a job type for the user.

In some aspects, the techniques described herein relate to a computer program product, wherein the at least one executable portion is further configured to generate the user profile associated with the user, wherein the user profile indicates the training type for the user.

In some aspects, the techniques described herein relate to a computer program product, wherein the at least one executable portion is further configured to verify completion of the at least one training module via a user verification, wherein the user verification includes monitoring the computing device associated with the user for engagement with the at least one training module.

In some aspects, the techniques described herein relate to a computer program product, wherein the user verification is completed via monitoring a user input relating to the at least one training module.

In some aspects, the techniques described herein relate to a computer program product, wherein the user verification is completed via visual verification using a camera connected to the computing device associated with the user.

In some aspects, the techniques described herein relate to a computer program product, wherein the user verification includes receiving at least one of a picture or a video of the user completing the at least one training module.

In some aspects, the techniques described herein relate to a computer program product, wherein the at least one executable portion is further configured to verify the user completed the at least one training module based on the at least one of the picture or the video of the user completing the at least one training module.

In some aspects, the techniques described herein relate to a computer program product, wherein the at least one executable portion is further configured to generate the at least one training module, wherein the at least one training module is assigned to a training type.

In some aspects, the techniques described herein relate to a computer program product, wherein generating the at least one training module includes converting a training material for viewing via the computing device associated with the user.

In some aspects, the techniques described herein relate to a computer program product, wherein generating the at least one training module includes generating the knowledge verification quiz for each of the at least one training module.

In some aspects, the techniques described herein relate to a computer program product, wherein each training type is associated with a training set, wherein the training set includes the at least one training module to assign to the user based on the training type.

In some aspects, the techniques described herein relate to a computer program product, wherein the at least one executable portion is further configured to update the training set for the user based on one or more previously completed training modules, wherein the one or more previously completed training modules are removed from the at least one training module assigned to the user.

In some aspects, the techniques described herein relate to a computer program product, wherein the user interface is rendered as a platform for a user to engage via the computing device associated with the user.

In some aspects, the techniques described herein relate to a computer program product, wherein the at least one training module includes at least one video, wherein the at least one video must be viewed from a start to a finish to verify completion of the at least one training module.

In some aspects, the techniques described herein relate to a computer program product, wherein the knowledge verification quiz is available to complete upon completion of the at least one video.

In some aspects, the techniques described herein relate to a computer program product, wherein the at least one executable portion is further configured to generate a training compliance report, wherein the training compliance report indicates a completion status for each of the at least one training module.

In some aspects, the techniques described herein relate to a computer program product, wherein the training compliance report relates to the user and at least one additional user.

In some aspects, the techniques described herein relate to a computer program product, wherein the at least one executable portion is further configured to cause a certification to be provided to the user based on the completion of the at least one training module.

In some aspects, the techniques described herein relate to a computer program product, wherein the at least one executable portion is further configured to assign a new training module to the user based on the training type of the user; wherein the new training module is assigned upon creation and association with the training type.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 provides a block diagram illustrating a system environment for generating and assigning automated training accreditation across remote devices, in accordance with various embodiments of the present disclosure;

FIG. 2 provides a block diagram illustrating the training management server(s) 151 of FIG. 1, in accordance with various embodiments of the present disclosure;

FIG. 3 provides a block diagram illustrating the computing device(s) 152 of FIG. 1, in accordance with various embodiments of the present disclosure;

FIG. 4 illustrates an example platform dashboard with information relating to work orders, in accordance with various embodiments of the present disclosure;

FIG. 5 illustrates an example platform dashboard with information relating to users (e.g. employees), in accordance with various embodiments of the present disclosure;

FIG. 6 illustrates a task checklist completed on the platform, in accordance with various embodiments of the present disclosure;

FIG. 7 illustrates an example platform dashboard including a file vault relevant to a given user, in accordance with various embodiments of the present disclosure;

FIG. 8A illustrates a manual task configuration within the platform, in accordance with various embodiments of the present disclosure;

FIG. 8B is an administrative view of the knowledge verification quiz list that may be assigned to various users, in accordance with various embodiments of the present disclosure;

FIG. 9 illustrates a knowledge verification quiz creation allowing a knowledge verification quiz to be made to verify training compliance, in accordance with various embodiments of the present disclosure;

FIG. 10 illustrates a file vault with a video assigned for a training module, in accordance with various embodiments of the present disclosure;

FIG. 11 illustrates an example file vault with videos for training purposes, in accordance with various embodiments of the present disclosure;

FIG. 12 illustrates a user view of a training module within the platform, in accordance with various embodiments of the present disclosure;

FIG. 13 illustrates a screen view of an employee training status interface, in accordance with various embodiments of the present disclosure;

FIG. 14A illustrates a knowledge verification quiz that includes multiple choice answers, in accordance with various embodiments of the present disclosure;

FIG. 14B illustrates the results of the knowledge verification quiz provided to a user via the platform, in accordance with various embodiments of the present disclosure;

FIG. 15 is a flow chart that details a method of generating and assigning automated training accreditation across remote devices, in accordance with various embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Overview

Across different industries, entities have difficulty creating a standard of training. Certain industries require employees to undergo certain training and/or receive certain certifications from such trainings. An example industry that may use the platform discussed herein is the janitorial industry. In the janitorial industry, no standard of training has been effectively created. Instead, most or all of training is conducted via word of mouth and/or paper guidelines established by individual entities. However, such training often fails to prepare workers, as the training is largely based on the trainer. Additionally, many workers are remote, and training cannot be done in person. Virtual training produces large scale issues, especially relating to verification of training completion. Additionally, virtual training allows the potential for non-users to complete training and may result in a user passing training and/or receiving an accreditation without actually completing the training. As the workforce has become more remote, the use of disparate remote devices to complete training has presented serious issues relating to verification and validation.

Various industries and/or entities may require one or more certifications that must be validated in order for a new employee to perform aspects of the job. Using the janitorial industry as an example, a person may be required to receive a certain certification to work in certain types of buildings. For example, an employee may need a Cleaning Industry Management Standard (CIMS) certification through the ISSA organization to clean government facilities. Currently the ISSA requires binders with all pertinent information for training, site specific requirements, and overall guidelines that the janitorial company will adhere to be presented to a new hire by a supervisor/manager. The process of presenting the binder takes about 45 minutes to an hour to complete. At the end of the presentation a signature page for all information is required to show competence. However, not all supervisors/managers are trained themselves and little is completed outside of getting a new hire to sign the document. Various embodiments of the present disclosure allow for verification of training, as well as collection and/or maintenance of any necessary documentation.

Various embodiments of the present disclosure provide for a training platform that allows for actual training and verification across users at different locations. Each training module of the present disclosure may be customizable to include user verification (e.g., a user may verify and/or virtually sign any documents necessary for certifications), knowledge verification (e.g., knowledge verification quizzes to confirm the training module was completed), material completion verification (e.g., verifying a video was watched completely and/or a document was scrolled from top to bottom), and/or the like. The centralized platform allows training to be customized for a user and avoid any unnecessary training to be completed. A user (whether a new employee or current employee) may be assigned trainings based on the job capacity of the user. As such, the platform may have automated assignments of training based on a user profile associated with the user. For example, a user profile associated with the user may indicate the type of jobs performed by the user and the trainings may be tailored based on the job.

In various embodiments, the present disclosure addresses technical issues arising in remote-device training environments, including unreliable verification of whether an intended user actually accessed training content, difficulty correlating content interaction across disparate computing devices, and limited ability to control downstream platform access based on verified training completion. Various embodiments improve operation of the training platform by combining remote rendering of training materials with device-side engagement monitoring, conditional presentation of knowledge verification content, user-specific verification using camera-enabled visual data, and automated updating of access permissions and training assignments based on verified completion results. As such, the disclosed systems are not limited to organizing training information, but instead improve integrity, attribution, and enforcement of training completion across distributed computing devices.

In various embodiments, the platform may further improve remote-device operation by selectively rendering only training modules relevant to a user profile and training state, suppressing redundant training content based on previously completed modules, and storing verification records associated with device sessions, completion attempts, and verification outcomes. In this regard, the disclosed techniques may reduce unnecessary user-interface interactions, improve consistency of verification across different device types, and provide a computer-implemented mechanism for gating access to operational platform functionality until corresponding training requirements have been technically verified.

Example use cases include industries requiring verifiable training, such as service industry (e.g., janitorial), finance, healthcare, government, and e-commerce. The systems discussed herein may also be used by organizations that need to train multiple users across different locations for different types of responsibilities.

In some aspects, the techniques described herein relate to a method of generating and assigning automated training accreditation across remote devices, the method including: determining a training type of a user based on a user profile associated with the user, wherein the training type indicates a type of training to be assigned to the user; determining at least one training module to assign to the user profile based on the training type; causing a rendering of a user interface that includes the at least one training module to a computing device associated with the user; and verifying completion of the at least one training module, wherein the completion of the at least one training module is verified using knowledge verification, wherein the knowledge verification includes completing a knowledge verification quiz relating to the at least one training module.

Systems of various embodiments may include at least one non-transitory storage device with at least one processing device coupled to the at least one non-transitory storage device, with the at least one processing device is configured to carry out the methods discussed herein. The present disclosure also provides for computer program products including at least one non-transitory computer-readable medium having one or more computer-readable program code portions embodied therein with the one or more computer-readable program code portions including at least one executable portion configured to carry out the methods discussed herein.

### II. With Reference to the FIGs.

Reference will now be made in detail to aspects of the disclosure, examples of which are illustrated in the accompanying drawings. The following description refers to the accompanying drawings in which the same numbers in different drawings represent the same or similar elements unless otherwise represented. The implementations set forth in the following description do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

Systems, methods, and apparatuses are described herein which relate generally to generating and assigning automated training accreditation across remote devices. In the following description, for purposes of explanation, numerous specific details are set forth to provide a thorough understanding of the present disclosure. It will be evident, however, to one skilled in the art that the present disclosure may be practiced without these specific details and/or with any combination of these details.

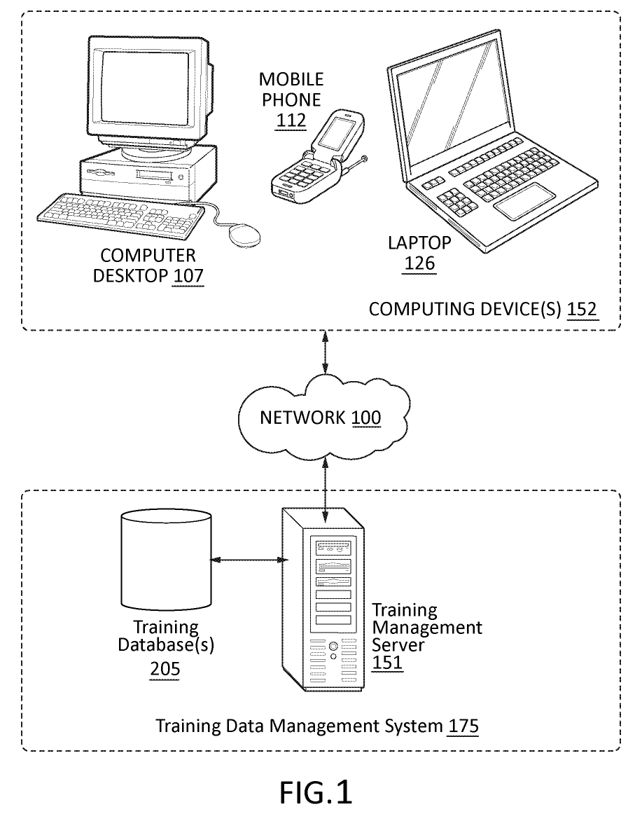

Referring now to FIG. 1, a block diagram illustrating a system environment (“system”) for generating and assigning automated training accreditation across remote devices, in accordance with various embodiments is provided. The system includes computing device(s) 152 and a training data management system 175 connected to a network 100. As shown, the computing device(s) 152 (e.g., desktop computer 107, mobile phone 112, laptop 126, and/or the like) associated with accounts are in communication with network 100. Computing device(s) 152 may be associated with users (e.g., associated with various entities, administers, employee users, and/or the like). The network 100 may be any type of wired and/or wireless connection, such as wi-fi, ethernet, Bluetooth, cellular, and/or the like.

The training data management system 175 is also in communication with the network 100. The training data management system 175 includes one or more training management servers 151 and one or more training databases 205. In various embodiments, the training management server(s) 151 may be made of multiple servers. In various embodiments, the training database(s) 205 may be part of the training management server(s) 151 (e.g., at least a portion of the training database(s) 205 may be stored on the memory device(s) 268 of the training management server(s) 151). Additionally or alternatively, at least a portion of the training database(s) 205 may be stored remote from the training management server(s) 151. The training database(s) 205 may be part or, or in communication with the training data management system 175. The training database(s) 205 may include entity data for one or more entities. The training database(s) 205 may include the training materials across multiple entities, locations, tasks, job types, and/or the like. The training database(s) 205 may include one or more training modules discussed herein. For example, the training database(s) 205 may include training materials (e.g. videos, documents, etc.) and information relating to the training materials (e.g., knowledge verification quizzes; associated locations, tasks, job types, entities, and/or the like; etc.).

In various embodiments, the system environment shown in FIG. 1 may support delivery of training materials and corresponding knowledge verification content to a plurality of computing device(s) 152 associated with different users across different locations. For example, the computing device(s) 152 may be associated with employees, administrators, supervisors, managers, and/or other users that interact with the platform for purposes of assigning training, completing training, monitoring training status, and/or reviewing compliance information.

In various embodiments, the training data management system 175 may centrally store and manage training modules, user profiles, training sets, knowledge verification quizzes, completion records, and/or other training-related information for one or more entities. As such, the training data management system 175 may determine training requirements for users based on job type, assigned tasks, assigned locations, entity rules, and/or other training types and may cause corresponding training modules to be rendered to remote computing device(s) 152 through the network 100.

In various embodiments, the system environment of FIG. 1 may further support verification of training completion across remote devices by combining access to training materials with one or more verification techniques, such as knowledge verification, activity monitoring, user verification, visual verification, and/or the like. The resulting completion information may be stored within the training database(s) 205 and used to generate training compliance reports, determine user eligibility for tasks or locations, and/or cause certifications or confirmations to be provided.

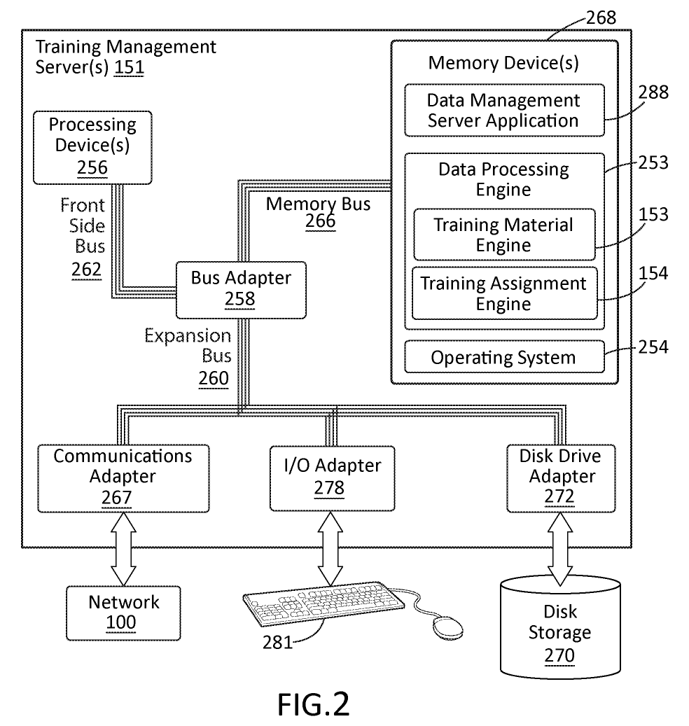

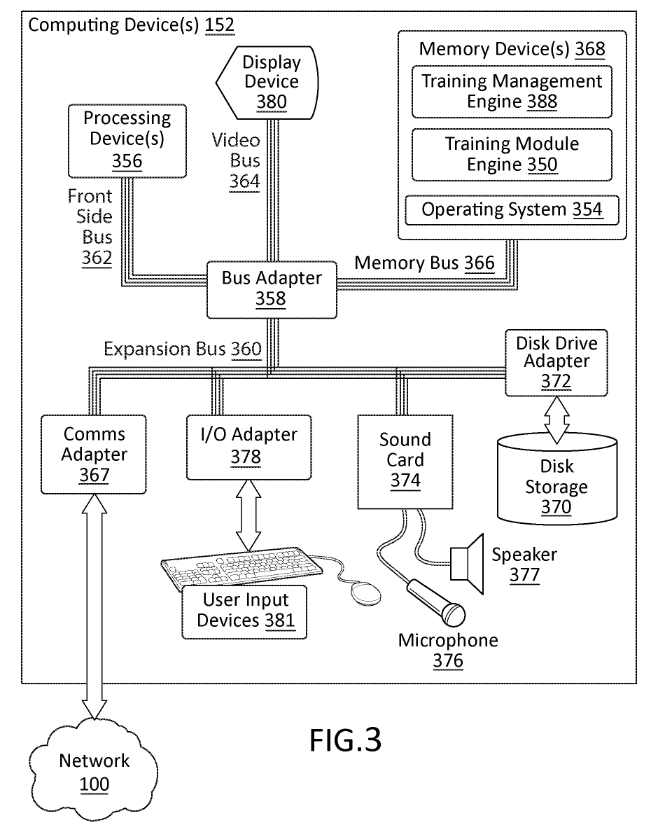

Referring now to FIG. 2, a block diagram illustrating the training management server(s) 151 of FIG. 1 in accordance with various embodiments is provided. FIG. 2 is merely illustrative of an example training management server(s) 151. In various embodiments, the training management server(s) 151 may share components with the computing device(s) 152 (e.g., the training management server(s) 151 may use at least a portion of the processing device(s) 356 of the computing device(s) 152 shown in FIG. 3). The training management server(s) 151 may be comprised of one or more servers. In various embodiments, the training management server(s) 151 may be capable of processing user inputs via a computing device(s) 152 and generating user interfaces to be rendered to computing device(s) 152.

The training management server(s) 151 of FIG. 2 includes one or more processing devices 256 and one or more memory devices 268, communication adapter 267, an input/output adapter 278, and a disk drive adapter 272. In various embodiments, the various components may be connected to one another via a BUS adapter 258 (e.g., the processing device(s) 256 may be attached via a front side BUS 262, the memory device(s) 268 may be attached via a memory BUS 266, and the communication adapter 267, I/O adapter 278, disk drive adapter 272, and/or other interfaces may be attached via expansion BUS 260). Any number of connection and/or communication methods may be contemplated for the various components.

It should be understood that the memory device(s) 268 may include one or more databases or other data structures/repositories. The memory device(s) 268 also includes computer-executable program code that instructs the processing device(s) 256 to operate the network communication interface (e.g., communication adapter 267) to perform certain communication functions of the system described herein. For example, in one embodiment of the training management server(s) 151, the memory device(s) 268 includes, but is not limited to, a data management server application 288, a data processing engine 253, and an operating system 254. The data processing engine 253 may also include a training material engine 153, a training assignment engine 154, and/or the like with instructions to carry out the processing of the entity data. The training material engine 153 may include instructions for creating and/or receiving training materials, as well as associating training materials with other portions of a training module (e.g., associating the training materials with a knowledge verification quiz). The training assignment engine 154 may include instructions for assigning training modules to users, as discussed herein (e.g., assigning based on assignment of a task).

In various embodiments, the training material engine 153 may be configured to generate, receive, convert, organize, and/or associate training materials for use within one or more training modules. For example, the training material engine 153 may receive uploaded videos, documents, images, and/or other instructional materials and may associate such materials with corresponding knowledge verification quizzes, tasks, locations, job types, and/or training types.

In various embodiments, the training assignment engine 154 may be configured to determine one or more training modules to assign to a user based on a user profile associated with the user. For example, the training assignment engine 154 may evaluate information relating to job title, assigned location, assigned tasks, prior completion information, required certifications, and/or entity-specific rules in order to identify a training set for the user and update such training set over time as assignments or training requirements change.

In various embodiments, the data processing engine 253 may further be configured to evaluate whether completion of a training module has been verified based on one or more verification inputs received through the platform. For example, the data processing engine 253 may process results of knowledge verification quizzes, monitored engagement with training materials, user input activity, images or video associated with visual verification, and/or other completion-related information to determine whether a user has satisfied a corresponding training requirement.

Some embodiments of the training management server(s) 151 include processing device(s) 256 communicably coupled to such components as the memory device(s) 268, the communication adapter 267, the input/output adapter 278, the disk drive adapter 272, and/or the like. The processing device(s) 256, and other processors described herein, generally include circuitry for implementing communication and/or logic functions of the system. For example, the processing device(s) 256 may include a digital signal processor device, a microprocessor device, and various analog to digital converters, digital to analog converters, and/or other support circuits. Control and signal processing functions of the training management server(s) 151 are allocated between these devices according to their respective capabilities. The processing device(s) 256 thus may also include the functionality to encode and interleave messages and data prior to modulation and transmission. The processing device(s) 256 can additionally include an internal data modem. Further, the processing device(s) 256 may include functionality to operate one or more software programs, which may be stored in the memory device(s) 268. For example, the processing device(s) 256 may be capable of operating a connectivity program to communicate via the communication adapter 267.

The processing device(s) 256 is configured to connect to the network 100 via the communication adapter 267 to communicate with one or more other devices on the network 100. In this regard, the communication adapter 267 may include various components, such as an antenna operatively coupled to a transmitter and a receiver (together a “transceiver”). The processing device(s) 256 is configured to provide signals to and receive signals from the transmitter and receiver, respectively. The signals may include signaling information in accordance with the air interface standard of the applicable cellular system of the network 100. In this regard, the training management server(s) 151 may be configured to operate with one or more air interface standards, communication protocols, modulation types, and access types. By way of illustration, the training management server(s) 151 may be configured to operate in accordance with any of a number of first, second, third, fourth, and/or fifth-generation communication protocols and/or the like. In various embodiments, the training management server(s) 151 may also be connected via other connection methods to one or more components of the training data management system 175.

The I/O adapter 278, which allows the training management server(s) 151 to receive data from a user such as a system administrator, may include any of a number of devices allowing the training management server(s) 151 to receive data from the user, such as a keypad, keyboard 281, touch-screen, touchpad, microphone, mouse, joystick, other pointer device, button, soft key, and/or other input device(s). The user interface may also include a camera, such as a digital camera.

The disk drive adapter 272 may provide additional storage space via disk storage 270. Various other storage mediums may also be used by the training management server(s) 151, such as cloud storage (e.g., transmitted via the communication adapter 267).

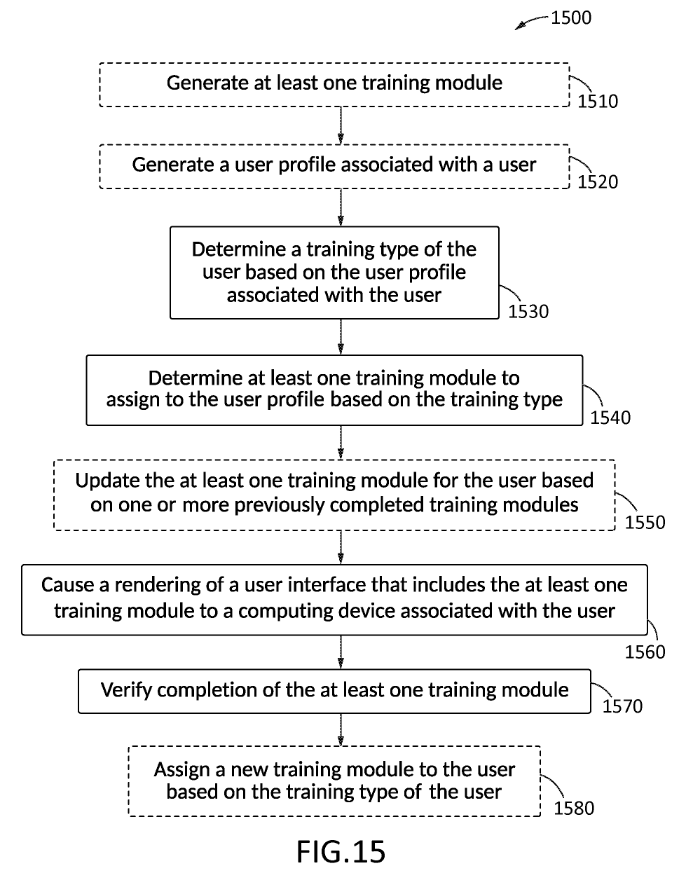

Referring now to FIG. 3, a block diagram illustrating the computing device(s) 152 of FIG. 1, in accordance with various embodiments is provided. FIG. 3 is merely illustrative of an example computing device(s) 152. Various types of computing device(s) 152 may be used or otherwise contemplated for the system. The computing device(s) 152 may be any computing device that is used to carry out the operations herein (e.g., as discussed in reference to the flow chart 1500 of FIG. 15).

Example computing devices include desktop computers 107, mobile devices, such as mobile phones 112, tablets, smart watches, etc., laptops 126, and/or the like. As such, the computing device(s) 152 may be any device that is capable of performing the operations discussed herein. For example, a mobile phone may include communication interfaces to communication with mobile networks and local area networks (e.g., via Wi-Fi).

The computing device(s) 152 of FIG. 3 includes one or more processing devices 356, one or more memory devices 368, a display device 380, a communication adapter 367, an input/output adapter 378, and a disk drive adapter 372. In various embodiments, the various components may be connected to one another via a BUS adapter 358 (e.g., the processing device(s) 356 may be attached via a front side BUS 362, the memory device(s) 368 may be attached via a memory BUS 366, the display device 380 may be attached via a video BUS 364, and the communication adapter 367, I/O adapter 378, disk drive adapter 372, and/or other interfaces may be attached via expansion BUS 360). Any number of connection and/or communication methods may be contemplated for the various components.

It should be understood that the memory device(s) 368 may include one or more databases or other data structures/repositories. The memory device(s) 368 also includes computer-executable program code that instructs the processing device(s) 356 to operate the network communication interface (e.g., communication adapter 367) to perform certain communication functions of the system described herein. The memory device(s) 368 may include a training management engine 388 with instructions on receiving data and/or processing data as discussed herein. The memory device(s) 368 also includes a training module engine 350 that includes instructions on generating and/or assigning training modules as discussed herein. The memory device(s) 368 may also include the operating system 354 of the computing device(s) 152, which may determine the folder and/or file formatting.

Some embodiments of the computing device(s) 152 include processing device(s) 356 communicably coupled to such components as the memory device(s) 368, the communication adapter 367, the input/output adapter 378, the disk drive adapter 372, and/or the like. The processing device(s) 356, and other processors described herein, generally include circuitry for implementing communication and/or logic functions of the system. For example, the processing device(s) 356 may include a digital signal processor device, a microprocessor device, and various analog to digital converters, digital to analog converters, and/or other support circuits. Control and signal processing functions of the computing device(s) 152 are allocated between these devices according to their respective capabilities. The processing device(s) 356 thus may also include the functionality to encode and interleave messages and data prior to modulation and transmission. The processing device(s) 356 can additionally include an internal data modem. Further, the processing device(s) 356 may include functionality to operate one or more software programs, which may be stored in the memory device(s) 368. For example, the processing device(s) 356 may be capable of operating a connectivity program to communicate via the communication adapter 367.

The processing device(s) 356 is configured to connect to the network 100 via the communication adapter 367 to communicate with one or more other devices on the network 100. In this regard, the communication adapter 367 may include various components, such as an antenna operatively coupled to a transmitter and a receiver (together a “transceiver”). The processing device(s) 356 is configured to provide signals to and receive signals from the transmitter and receiver, respectively. The signals may include signaling information in accordance with the air interface standard of the applicable cellular system of the network 100. In this regard, the computing device(s) 152 may be configured to operate with one or more air interface standards, communication protocols, modulation types, and access types. By way of illustration, the computing device(s) 152 may be configured to operate in accordance with any of a number of first, second, third, fourth, and/or fifth-generation communication protocols and/or the like).

The I/O adapter 378, which allows the computing device(s) 152 to receive data from a user such as a system administrator, may include any of a number of devices allowing the computing device(s) 152 to receive data from the user, such as a keypad, keyboard 381, touch-screen, touchpad, microphone, mouse, joystick, other pointer device, button, soft key, and/or other input device(s). The user interface may also include a camera, such as a digital camera.

The disk drive adapter 372 may provide additional storage space via disk storage 370. Various other storage mediums may also be used by the computing device(s) 152, such as cloud storage (e.g., transmitted via the communication adapter 367).

As described above, the computing device(s) 152 has a user interface that is, like other user interfaces described herein, rendered via the display device 380. The display device 380 includes a display (e.g., a liquid crystal display or the like) and/or a speaker or other audio device, which are operatively coupled to the processing device(s) 356. As such, the folder(s) and/or file(s) discussed herein may be provided to the computing device(s) 152 via the display device 380 (e.g., visually via the user interface). In various embodiments, the display device 380 may be in communication with a sound card 374 (e.g., attached to a microphone 376 and/or a speaker 377 (e.g., the speaker 377 may be part of the display device 380 or standalone)).

In various embodiments, the computing device(s) 152 shown in FIG. 3 may be used to render one or more user interfaces of the platform, including training module interfaces, dashboard interfaces, employee status interfaces, file vault interfaces, quiz interfaces, and/or other interfaces discussed herein. As such, the display device 380 may be used to present training materials and knowledge verification content to a user, while the input/output adapter 378 may receive user interactions associated with viewing, scrolling, answering quiz questions, and/or otherwise engaging with the platform.

In various embodiments, the communication adapter 367 may allows the computing device(s) 152 to receive assigned training modules, transmit completion information, and communicate quiz responses and/or status data to the training data management system 175 through the network 100. In this regard, the computing device(s) 152 may support remote access to the platform for users located away from a central training location.

In various embodiments, one or more components of the computing device(s) 152 may be used as part of verifying completion of a training module. For example, the display device 380 and training module engine 350 may present a training video or document, the input/output adapter 378 may detect user engagement with the training materials, and the microphone 376 and/or other camera-enabled or audio-enabled components associated with the computing device(s) 152 may be used in connection with user verification and/or visual verification during completion of a training module.

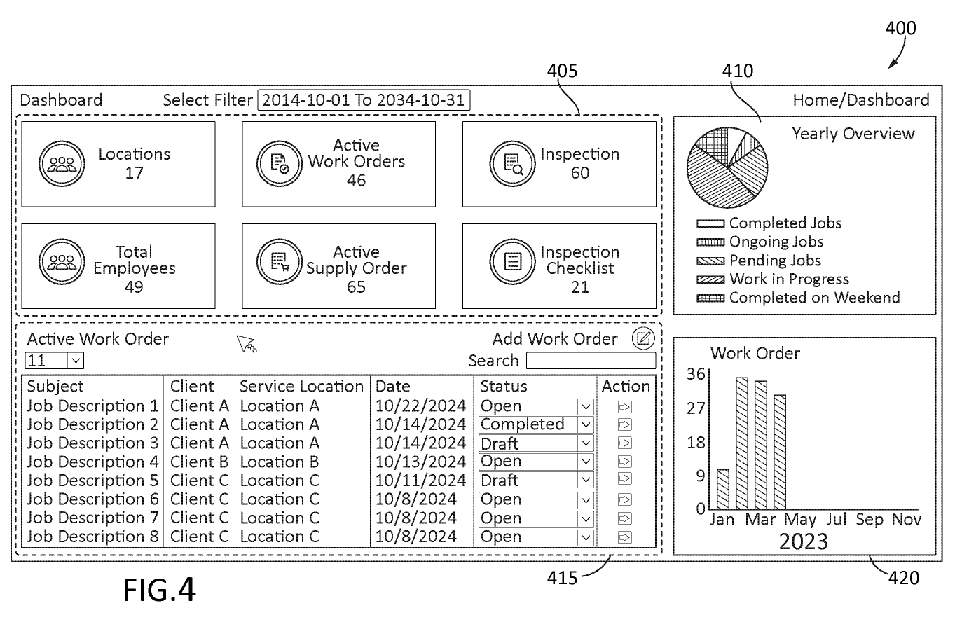

FIGS. 4-14B illustrate various user interfaces provided via the platform. The user interfaces may be customized based on the user. For example, a user may be an administrator, an employee, and/or the like. As such, the platform may be customized for the given user. In various embodiments, the user interfaces may be rendered on any display of the system, such as a display device 380 of one of the computing device(s) 152. For example, a user may log into a profile on a computing device and the user interface may be rendered as discussed herein.

Referring now to FIG. 4, an example platform dashboard with information relating to work orders is provided. In various embodiments, the user interface of the platform dashboard may be different based on the type of user. For example, the user interface 400 of FIG. 4 may be the platform dashboard for an administrator. As shown, the user interface may have different areas with information relating to an entity associated with a user. As shown, the platform dashboard may include an overview portion 405. The overview portion may include one or more blocks with information relevant to the user. For an administrator, the overview portion may include blocks relating to the entity that the user is associated. For example, the overview portion includes blocks for the number of locations, the number of employees, the number of active work orders, the number of supply orders, the number of inspections, the number of pending inspection checklists, and/or the like. The block of the overview portion 405 may be customizable by the user and/or tailored for different entity types (e.g., a janitorial entity may have a block for inspections, while other entities may have blocks for other types of services).

In various embodiments, one or more blocks of the overview portion 405 may be engageable, such that additional information relating to the block is accessed. In the example shown in FIG. 4, the active work orders block has been selected and the user interface may display information relating to the work orders. For example, the work order portion 410 and the work order portion 420 include visual representation relating to the work orders (e.g., the work order portion 410 includes a pie graph with cumulative work orders that illustrate the percentage of jobs completed, ongoing, pending, work in progress, or completed during a weekend and the work order portion 420 includes a bar graph of work order each month). Any number of visual representations may be contemplated and/or displayed. The work order portion 415 illustrates information relating to the work orders, such as job description, client name, location information, date, status, and/or the like.

The work order portion 415 may be static (e.g., a user may only be able to view the information). Alternatively, the work order portion 415 may be adjustable (e.g., a user may be able to manually change job information, such as changing the status). The ability to change anything within the platform dashboard may be based on permissions. For example, a first user (e.g., a supervisor) may have more permissions to change information than a second user (e.g., a non-supervisor). While the work order portion 415 is displayed on the same user interface as the overview portion 405, in various embodiments, the engagement of a block of the overview portion may result in moving to another user interface screen.

In various embodiments, the user interface 400 of FIG. 4 may serve as an administrative dashboard through which a user may monitor operational information and training-related information associated with an entity. For example, the overview portion 405 may provide a summary of entity-level metrics, while one or more selectable blocks within the overview portion 405 may be used to access more detailed information relating to the selected category.

In various embodiments, engagement with a selected block of the overview portion 405 may cause the system to update one or more other portions of the user interface 400 to present category-specific information. For example, selection of an active work orders block may cause the work order portion 415 and/or work order portion 420 to display detailed data, charts, trends, and/or status information relating to work orders associated with the entity. In this regard, the user interface 400 may support navigation between different operational views within the platform.

In various embodiments, the user interface 400 may also be used in conjunction with training compliance functionality discussed herein. For example, administrative users interacting with the dashboard may review whether assigned users are prepared to perform work reflected in the work order portion 415 based on completion of one or more corresponding training modules, certifications, and/or other training requirements. As such, the dashboard may provide an entity-level view that relates operational assignments to training readiness.

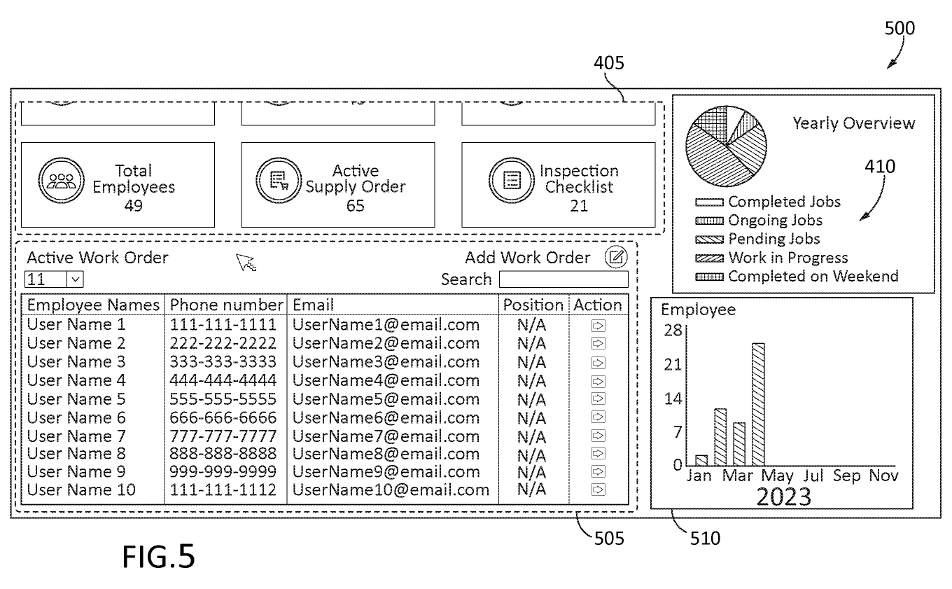

As shown in FIG. 5, as a different block of the overview portion 405 is engaged, the information displayed on the user interface is updated upon engagement. The user interface 500 displays the information shown in an instance in which the total employee block of the overview portion 405 is engaged. Some of the portions of the screen may be static (e.g., not change upon engagement of another block). For example, the work order portion 410 may remain the same and not update. However, other portions of the user interface may be updated with information relating to the selected block. As shown, the work order portions 415, 420 of FIG. 4 may be replaced with employee portions 505, 510. The employee portion 505 includes information relating to the employees (or users) associated with the entity. The employee information may include employee name (e.g., real name and/or username), contact information, position (e.g., job title), and/or the like. While the term employee is used, any number of different use cases may be used for the present disclosure. For example, the same functionality may be used for students, clients, and/or other use cases. The employee portion 510 may include a visual representation relating to the employee information (e.g., a bar graph of total employees over time is shown in FIG. 5).

In various embodiments, the employee portion 505 shown in the user interface 500 may correspond to a plurality of user accounts maintained through the platform. Each listed employee may be associated with a user profile that includes identifying information, job position, contact information, assigned locations, assigned tasks, completed training modules, outstanding training requirements, certifications, and/or other account-related information used by the system.

In various embodiments, the position and/or other employee information shown in the employee portion 505 may be used as part of determining a training type for the corresponding employee. For example, the platform may use the job position, assigned responsibilities, and/or associated work locations of an employee to determine one or more training modules to assign to the employee and to determine whether existing training assignments are to be updated as the employee’s responsibilities change.

In various embodiments, the user interface 500 may allow an administrator or other authorized user to review the users associated with an entity and to monitor workforce readiness across a plurality of employees. For example, the employee information shown through the employee portion 505 and the visual representation shown in the employee portion 510 may be used together with training status information to determine whether an entity has appropriately trained personnel for one or more tasks, services, and/or locations.

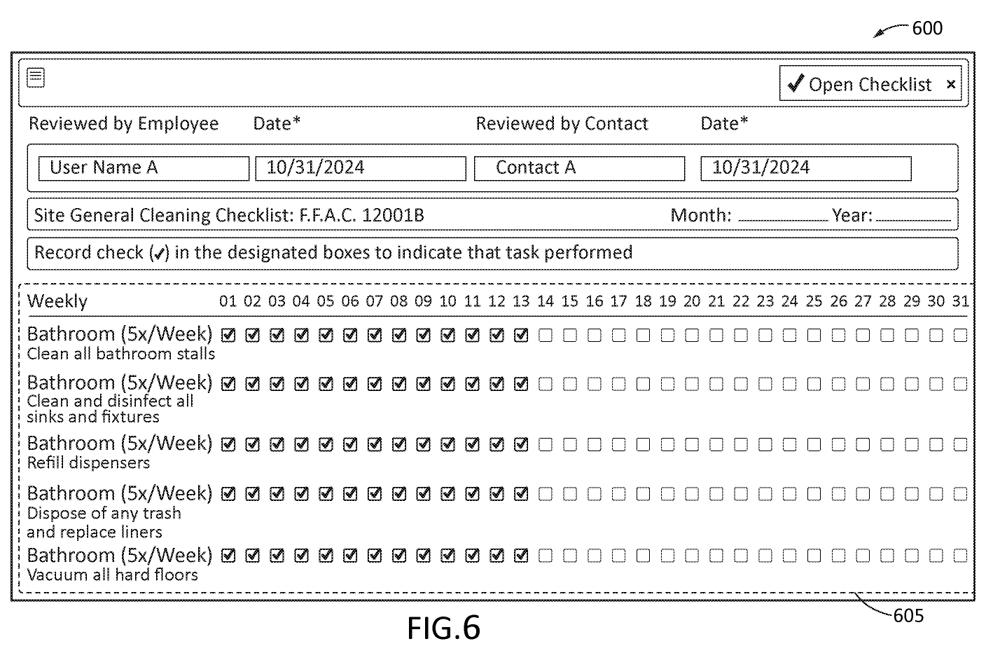

Referring now to FIG. 6, a task checklist completed on the platform is provided. In various embodiments, the platform may allow for both training and non-training activities to be tracked. For example, as shown in FIG. 6, a user may complete a task checklist within the platform. The user interface 600 shown in FIG. 6 may be a user (or employee) interface that is completed by an on-the-job employee. The checklist information may be accessible and/or reviewable by administrators.

The platform may be tailored based on the type of entity and/or type of users. As such, the platform may be used to monitor activity both during training and post-training. As shown in FIG. 6, a user interface 600 may be provided with a checklist to be completed by a user while completing tasks. For example, in the janitorial example, the checklist may include tasks that are part of providing cleaning services. The task checklist 605 may be used for iterative process. For example, commercial cleaning may be conducted repeatedly over a certain amount of time. In the example, certain tasks may be completed multiple times per week (e.g., bathrooms may be cleaned during weekdays). As such, the platform allows for tracking of such tasks. As discussed herein, the task checklist may be used for monitoring performance (e.g., in place of paper forms). The system may generate reports based on completed checklists.

In various embodiments, the checklists may be based on time and/or locations (e.g., areas within a location, such as bathroom, and/or different sites). For example, the task checklist 605 of FIG. 6 is related to weekly bathroom cleaning. In various embodiments, any number of different checklists may be contemplated for a task. For example, the task checklist may include individual steps, as shown in FIG. 6 and/or include broader instructions (e.g., clean office). The specific sub-tasks within the checklist may be changed and/or updated. The sub-tasks may be automated (e.g., commercial buildings may each receive similar cleaning tasks) and/or manually added and/or adjusted (e.g., a client may have specific requests for completion of sub-tasks during task performance). In various embodiments, certain types of tasks (or jobs) may have a template set of sub-tasks and the templated may be updated automatically and/or manually.

In various embodiments, the task checklist 605 may be associated with one or more tasks, locations, frequencies, and/or service categories assigned to a user through the platform. The task checklist 605 may therefore provide an operational interface through which a user records performance of work after completion of one or more corresponding training requirements.

In various embodiments, access to the task checklist 605 may depend on completion of one or more training modules associated with the underlying task, location, and/or job type. For example, the platform may determine whether a user has completed one or more training materials and corresponding knowledge verification quizzes before allowing the user to access the task checklist 605, log completion of tasks, and/or otherwise interact with operational functionality associated with the assigned work.

In various embodiments, the platform may control access to one or more operational portions of the platform based on whether completion of one or more corresponding training modules has been verified. For example, if a user has not completed a required training module associated with a task, location, service type, and/or job role, the system may restrict access to a task checklist, work order, file vault, location-specific interface, reporting interface, and/or other operational functionality associated with the incomplete training requirement.

In various embodiments, upon determining that completion of a required training module has been verified, the system may update one or more permissions associated with the user profile to enable access to one or more additional portions of the platform. For example, the system may permit the user to access a location-specific checklist, accept or log completion of an assigned task, view location-specific training assistance materials, and/or otherwise interact with portions of the platform that were previously restricted. In this regard, verified training completion may be used not only for recordkeeping, but also for operational access control within the platform.

In various embodiments, access control based on verified training completion may be applied at different levels of granularity. For example, a first training requirement may control access to an entire location, while a second training requirement may control access to only a particular task type, service category, customer-specific procedure, and/or equipment-related function within the platform. As such, the system may selectively enable or restrict user interactions based on the specific training requirements satisfied by the user.

In various embodiments, information entered through the task checklist 605 may be stored and used together with training completion information to generate compliance records, performance reports, inspection records, and/or other administrative outputs. As such, the task checklist 605 may provide a connection between training completion and later task execution within the same platform.

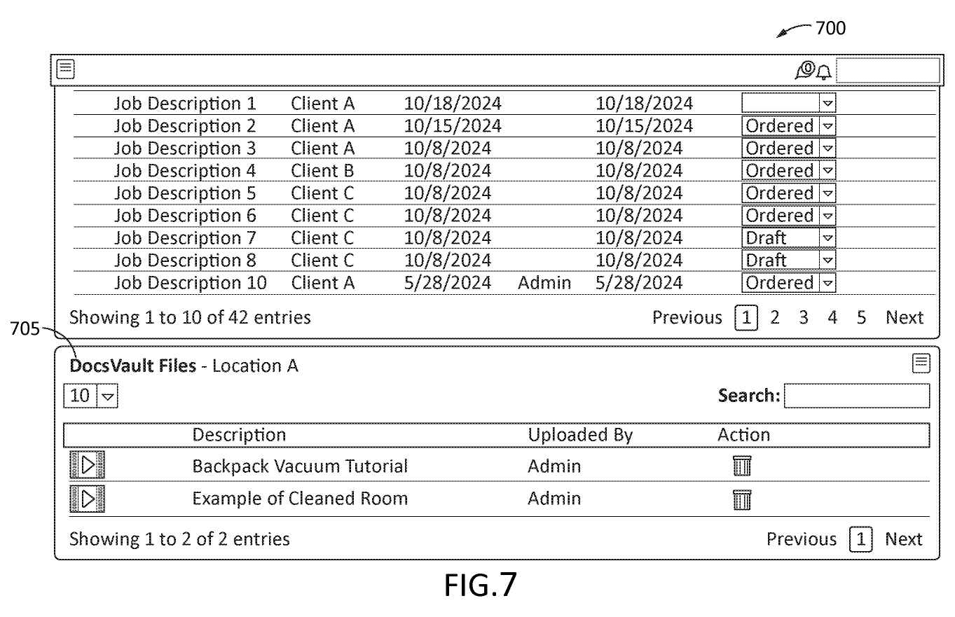

Referring now to FIG. 7, an example platform dashboard including a file vault relevant to a given user is provided. The user interface 700 illustrates an example file vault 705 used in various embodiments. The file vault may be used for training and/or assistance during performance of a task. For example, a user may access a file, such as a video, of the task being performed in order to know how the task is to be executed. In various embodiments, the file vault 705 may include various educational files, such as how-to guides and/or videos. The file vault 705 may be tailored to the user and/or task assigned to a user. For example, the file vault 705 displayed to the user in FIG. 7 illustrates a backpack vacuum tutorial and a video of an example cleaned room that may be relevant for location A.

The file vault may be automatically updated for the user based on the task being completed (e.g., a user completing a task checklist for a certain task may have a file vault displayed that is associated with the task). Additionally or alternatively, the user may select different tasks, locations, clients, and/or the like to view associated file vaults. Files within a file vault may be assigned to file vaults (e.g., via an administrator adding the file). For example, files uploaded by an administrator may be assigned to one or more specific file vaults and/or the files may be tagged with certain characteristics (e.g., cleaning tutorial) and the system may automatically assign the file to any relevant file vaults. The file vaults may be accessible via the platform discussed herein.

In various embodiments, the file vault 705 shown in the user interface 700 may provide a repository of training-related and task-related files made available to a user through the platform. Such files may include training videos, instructional documents, how-to guides, tutorials, customer-specific procedures, safety materials, and/or other educational content relevant to the user, assigned tasks, assigned locations, and/or job type.

In various embodiments, the files presented through the file vault 705 may be tailored based on one or more characteristics associated with the user. For example, the system may determine which files are to be displayed within the file vault 705 based on a task currently assigned to the user, a location associated with the user, a customer account, a service category, and/or a previously determined training type. As such, the file vault 705 may present different content to different users through the same platform.

In various embodiments, one or more files within the file vault 705 may correspond to training modules and/or materials associated with training modules that are to be completed by the user. In other embodiments, one or more files within the file vault 705 may be available as reference materials after completion of training. Accordingly, the file vault 705 may support both initial training delivery and later task assistance within the platform.

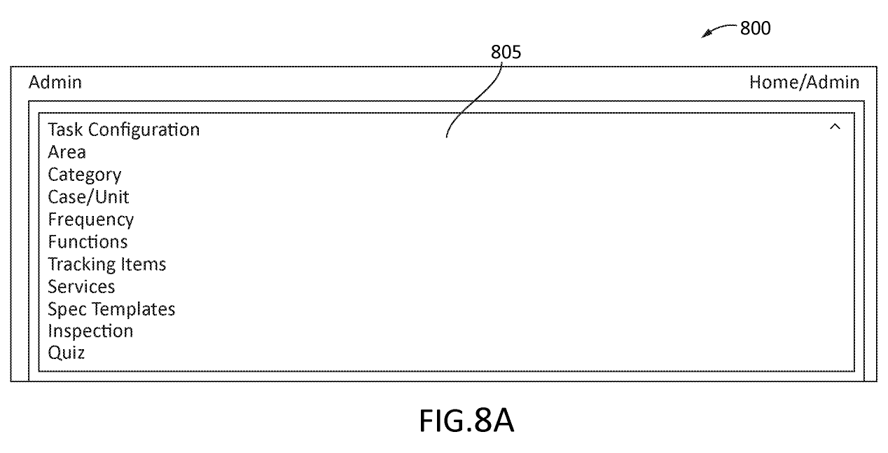

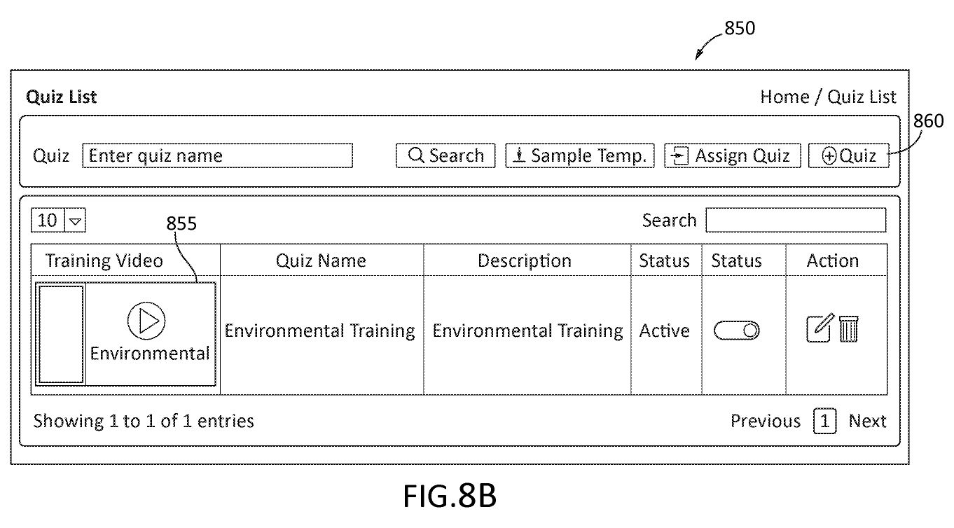

Referring now to FIG. 8A, a task configuration on the platform is provided. The task configuration may include the training type for the user profile assigned the specific job. In various embodiments, the task configuration may be for specific tasks (e.g., the task configuration may be complete for each task) and/or specific job titles (e.g., a task configuration may relate to the general tasks performed by a user). The task configuration may be completed automatically (e.g., a user may select a job type from a template) and/or manually (e.g., via input of information, as shown).

An example task configuration 805, as shown on user interface 800, may include information relating to the task (or job), such as area (e.g., location of task), category (e.g., type of task), case/unit (e.g., associated entities), frequency (e.g., how often the task is completed), functions, tracking items (e.g., sub-tasks), services, spec templates (e.g., is the task configuration the same or similar to other tasks to allow for a template to be used), inspection (e.g., how the entity judges performance), quizzes (e.g., knowledge verification quizzes), and/or the like.

In various embodiments, the knowledge verification quizzes may be associated with the at least one training modules. As such, upon assignment of a task, a user may be assigned the associated training module(s) and required to complete the knowledge verification quiz or quizzes before performing the task. The completion of the training module(s) may be a requisite for viewing other portions of the platform. For example, a user may not be able to access the associated task checklist before completing the training module(s) associated with the task. In various embodiments, the system may determine whether the user has completed the training module(s) before assignment of the task. For example, some tasks may require the same type of training, and the training module(s) may not have to be completed for each task.

Referring now to FIG. 8B, an administrative view of the knowledge verification quiz list that may be assigned to various users is provided. The user interface 850 includes one or more knowledge verification quizzes. The knowledge verification quiz list may include any number of training modules. As shown, a knowledge verification quiz 855 titled environmental training exists that is based on a training video. The knowledge verification quiz 855 may be required to be completed upon assignment to a user. The administrator may create new knowledge verification quizzes (e.g., via the create quiz icon 860). Created knowledge verification quizzes may be associated with existing training modules (e.g., existing videos on the system) and/or the administrator may upload training materials (e.g., training videos and/or documents) while creating the knowledge verification quizzes.

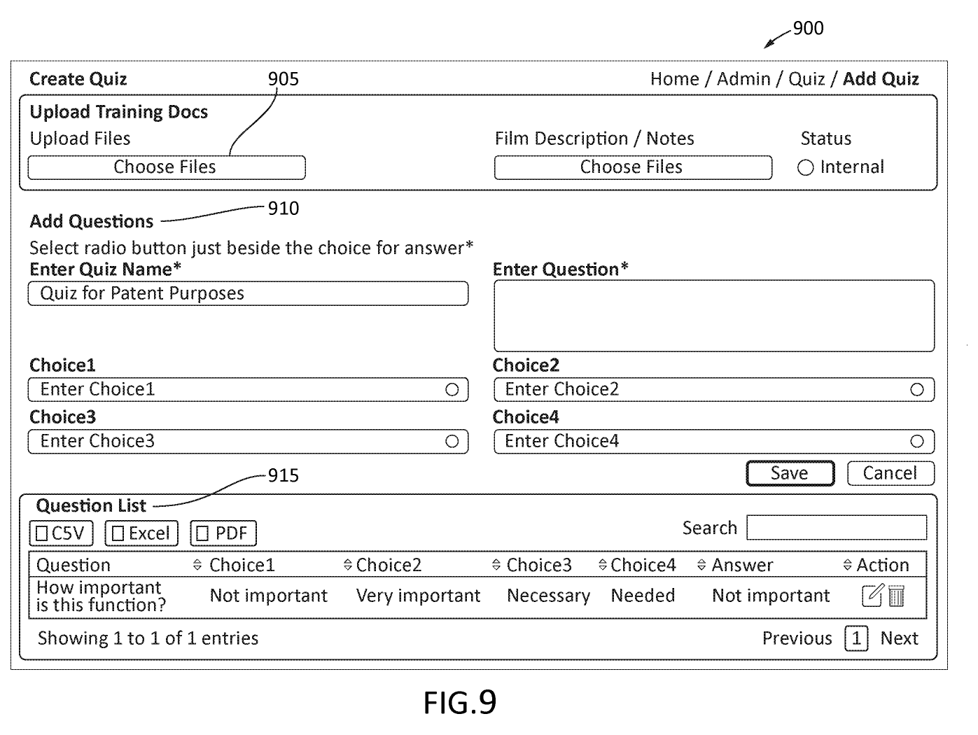

Referring now to FIG. 9, a user interface 900 showing the process of creating a knowledge verification quiz is provided. The creation of the knowledge verification quiz allows verification of training compliance. As shown, training material(s) for the training module may be uploaded (material upload 905) and/or associated with the quiz. An add question portion 910 may be provided to allow the administrator to add questions relevant to the training module. Example questions may be multiple choice, true/false, open-ended, and/or the like. Upon completion of the question, the question may be added to the question list 915. The questions may be reordered, deleted, and/or the like within the question list 915. Upon completion of the quiz, the training module (along with the knowledge verification quiz) may be associated with one or more tasks that are or may be assigned to a user.

In various embodiments, creation of the knowledge verification quiz may further include defining one or more scoring and completion parameters associated with the knowledge verification quiz. For example, an administrator may define a passing score threshold, assign different score values to different questions, determine whether all questions are to be answered correctly, determine whether partial credit is permitted, and/or otherwise define how successful completion of the knowledge verification quiz is to be evaluated.

In various embodiments, different knowledge verification quizzes may be associated with different completion requirements. For example, a first knowledge verification quiz associated with a high-risk task or location may require a higher passing score than a second knowledge verification quiz associated with a lower-risk task or location. In other embodiments, a knowledge verification quiz may require completion within a predefined time period, may permit a predefined number of attempts, and/or may trigger presentation of additional training materials in an instance in which the user does not satisfy the passing score threshold.

In various embodiments, the scoring and completion parameters established during creation of the knowledge verification quiz may be stored together with the knowledge verification quiz and later applied automatically when a user submits responses through the platform. As such, quiz creation may include not only defining quiz content, but also defining one or more rules by which successful completion of a corresponding training module is to be determined.

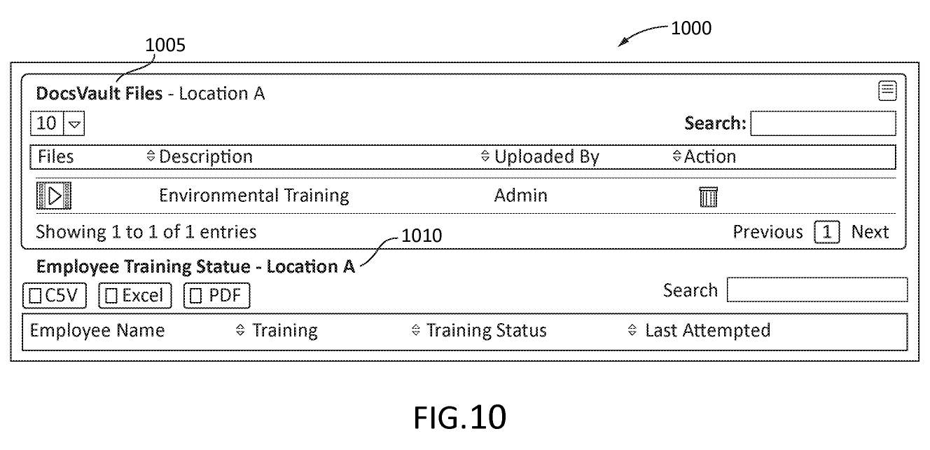

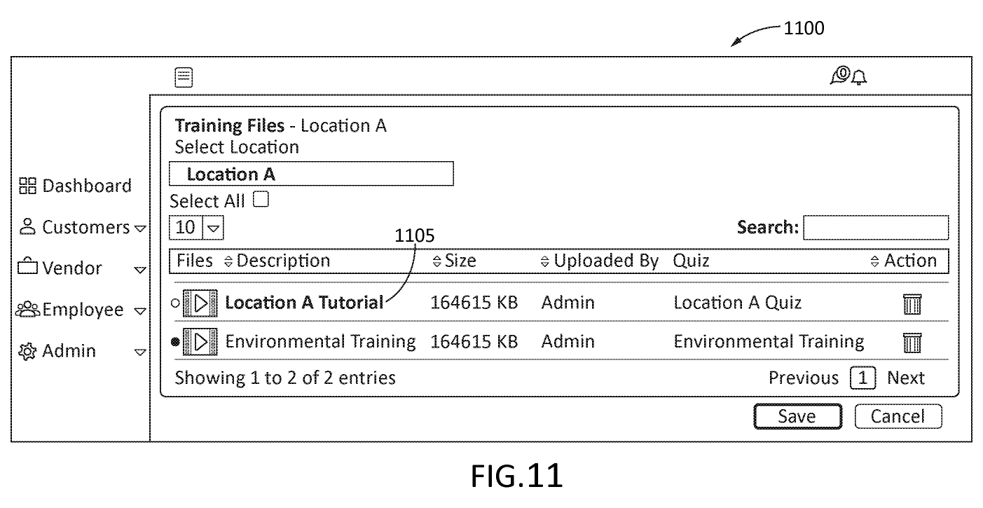

Referring now to FIGS. 10 and 11, user interfaces are shown with an example file vault with materials for a training module. The user interface 1000 includes a file vault 1005 for a location (e.g., a location at which a task may be assigned to a user). The user interface 1000 also includes information relating to employee training for the location. For example, the Employee training portion 1010 may include users assigned tasks at the location and/or users that may have completed training to work at the location (e.g., to operate at a location, certain training modules may need to be completed, and the employee training status may indicate users that are eligible and/or ineligible based on training status).

The user interface 1100 includes training files (or training modules) for specific locations. As discussed herein, the training modules may be assigned based on tasks, locations, job title, and/or the like. As shown in FIG. 11, a location A tutorial 1105 has been added. In such an instance, the user interface 1000 of FIG. 10 may be updated to include the location A tutorial training module. Any number of training modules may be assigned to a location, task, job title, and/or the like.

In various embodiments, the user interface 1000 may allow an administrator, supervisor, manager, and/or other authorized user to review training materials associated with a particular location and to monitor whether users associated with the location have satisfied one or more corresponding training requirements. For example, the file vault 1005 may include one or more training files, educational videos, tutorials, documents, and/or other training materials assigned for use at the location, while the employee training portion 1010 may indicate whether particular users have completed, not completed, and/or otherwise satisfied the training requirements associated with such materials.

In various embodiments, the training files associated with the file vault 1005 may correspond to one or more training modules assigned based on location, task, job title, user profile, and/or training type. As such, a user assigned to the location may be required to complete one or more training files represented within the file vault 1005 before the user is eligible to perform work at the location, access location-specific task checklists, and/or otherwise interact with operational portions of the platform associated with the location.

In various embodiments, the employee training portion 1010 may provide a location-based view of training compliance across a plurality of users. For example, the employee training portion 1010 may indicate users that are currently eligible to work at the location based on completed training modules and users that remain ineligible due to incomplete training requirements. In this regard, the user interface 1000 may be used to determine whether a user has completed location-specific training and whether additional training modules should be assigned before work is performed.

In various embodiments, the information presented through the user interface 1000 may be used as part of generating a training compliance report for the location. For example, completion information associated with the training files shown in the file vault 1005 and the status information shown in the employee training portion 1010 may be aggregated to generate records indicating training completion, outstanding training requirements, and/or user readiness for the location. Such records may be made available to authorized users through the platform and/or provided through one or more exported or transmitted reports.

In various embodiments, the training files listed in the user interface 1100 may represent training materials that are organized and stored for assignment to one or more users through the platform. Each listed file, such as the location A tutorial 1105, may correspond to a training module and/or a training material associated with a training module. For example, the location A tutorial 1105 may include a video, document, or other instructional content relating to procedures, requirements, safety protocols, customer-specific expectations, and/or site-specific operations for location A.

In various embodiments, the training files shown in the user interface 1100 may be associated with one or more locations, tasks, job types, service categories, entities, and/or training types. Upon association of a training file with a given location or other category, the system may determine one or more users to whom the corresponding training module is to be assigned. As such, addition of a new training file within the user interface 1100 may cause automated assignment of new or updated training requirements to users whose user profiles correspond to the associated location, task, and/or training type.

In various embodiments, the training files displayed in the user interface 1100 may also be associated with one or more knowledge verification quizzes such that completion of the training file alone is insufficient to satisfy the corresponding training requirement. For example, a listed training file may be associated with a knowledge verification quiz that becomes available upon completion of viewing and/or reviewing the training file. In such embodiments, the system may verify completion of the training module based on both access to the training file and successful completion of the associated knowledge verification quiz.

In various embodiments, the user interface 1100 may be used to update, replace, and/or add training files over time as training requirements change. For example, if a location-specific procedure changes or a new customer requirement is added, a new tutorial or revised training material may be added through the user interface 1100 and associated with the corresponding location or training type. The system may then determine whether one or more users should be assigned the new or revised training file as part of maintaining current training compliance.

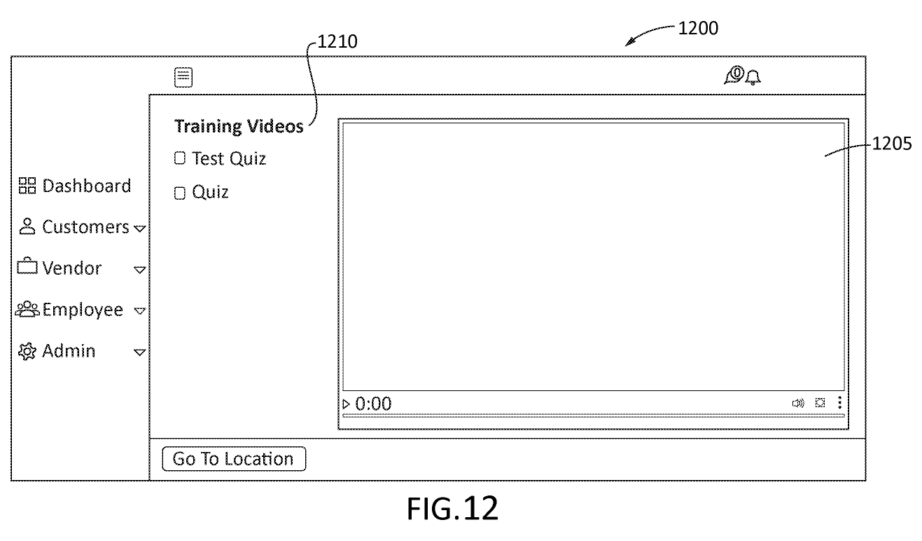

Referring now to FIG. 12, a user view of a training module within the platform is provided. User interface 1200 of FIG. 12 includes a training material portion 1205 and a quiz portion 1210. The training material portion 1205 shown in FIG. 12 is a video player. Any number of different file viewers and/or players may be used. For example, the training material may be a document, and a document viewer may be used in the training material portion 1205.

In various embodiments, the operation of the training material portion 1205 may be monitored, such as engagement (e.g., clicking to view and/or scroll a document). The training material portion 1205 may also be limited in functionality to ensure the user engage with the training material. For example, a video may have rewind functionality, but no fast forward functionality. In an example in which the training material is a document, the scrolling of the user (e.g., via an input device of the computing device associated with the user) on the document may be monitored to ensure that the document was at least scrolled from beginning to the end (i.e., from start to finish).

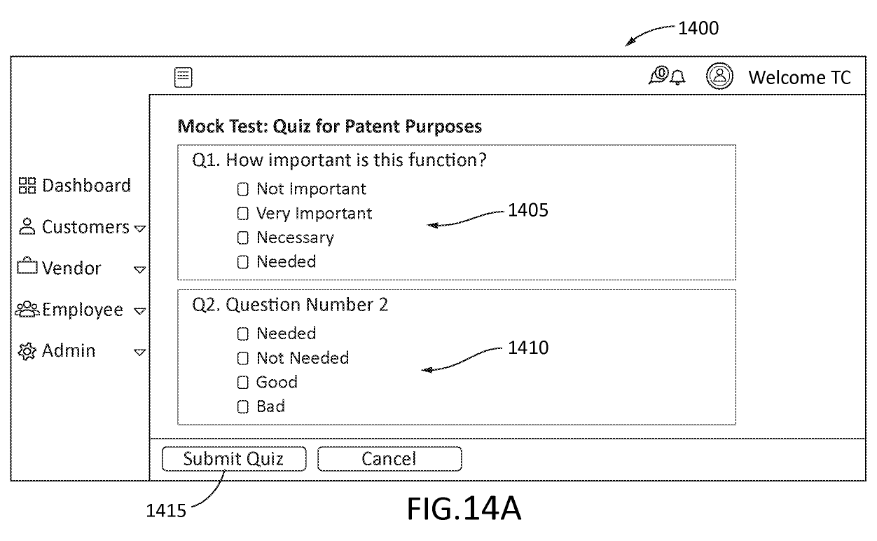

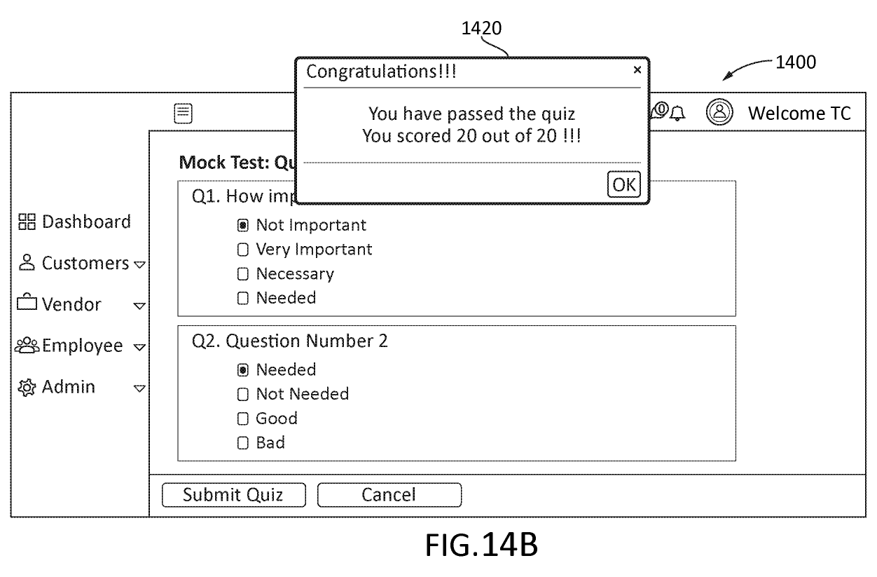

The quiz portion 1210 may be accessible or otherwise available during access to the training module (e.g., questions may be asked while the video is being played), at intervals during access to the training module (e.g., a portion of a training video may be viewed and then a question may be asked to the user), at the end of access to the training module (e.g., the questions may only be accessible at the completion of the video). In various embodiments, the quiz may be provided on an interface independent from the training material portion (as shown in FIGS. 14A and 14B). For example, the knowledge verification quiz may be provided or otherwise made available after the training materials are viewed.

In various embodiments, the user interface 1200 may be rendered to a computing device associated with the user as part of a training module assigned based on the user profile and/or training type of the user. The training material portion 1205 may present one or more training materials, such as a video, document, image sequence, audio content, and/or other instructional content, while the quiz portion 1210 may present one or more knowledge verification questions associated with the training material portion 1205. As such, the user interface 1200 may provide a unified training environment through which both training delivery and completion verification are performed.

In various embodiments, engagement of the user with the training material portion 1205 may be monitored as part of verifying completion of the training module. For example, the system may monitor whether a video has been viewed from start to finish, whether a document has been scrolled from a beginning to an end, whether one or more user inputs have been received during presentation of the training materials, and/or whether the user remains active on the user interface 1200 during access to the training module. In various embodiments, such engagement monitoring may be used alone or in combination with the knowledge verification quiz to determine whether the training module has been completed.

In various embodiments, the quiz portion 1210 may be made available at different times relative to presentation of the training materials. For example, one or more knowledge verification questions may be presented while the training material is being accessed, between segments of the training material, and/or after the training material portion 1205 has been completed. In an example in which the training material portion 1205 includes a video, the quiz portion 1210 may become available upon verifying that the video has been viewed from the start to the finish. In another example in which the training material portion 1205 includes a document, the quiz portion 1210 may become available upon verifying that the document has been reviewed from beginning to end.

In various embodiments, the user interface 1200 may further support user verification in addition to knowledge verification. For example, a camera associated with the computing device may capture one or more images and/or a video of the user during access to the training material portion 1205 and/or completion of the quiz portion 1210. The system may use such information to determine whether the user assigned to the training module is the same user accessing the training module. Accordingly, the user interface 1200 may support multiple forms of completion verification, including knowledge verification, engagement monitoring, and/or visual verification.

In various embodiments, successful completion of the training module through the user interface 1200 may cause the system to update a training status associated with the user, generate or update a training compliance record, enable access to one or more additional portions of the platform, and/or cause a certification or confirmation to be issued. For example, upon completion of the training material portion 1205 and successful completion of the quiz portion 1210, the system may determine that the user has satisfied a training requirement associated with a location, task, job type, and/or other training category.

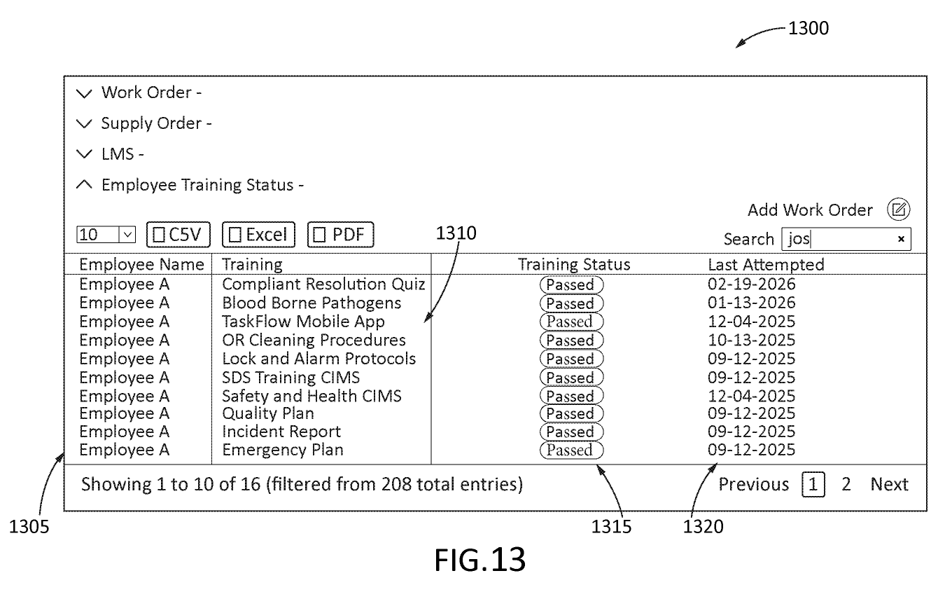

Referring now to FIG. 13, a screen view of an employee training status interface 1300 is provided. In various embodiments, the employee training status interface 1300 may be rendered via the platform discussed herein and may be accessible by an administrator, supervisor, manager, and/or other authorized user. The employee training status interface 1300 may provide a centralized view of training information for a plurality of users associated with an entity, location, task group, job type, and/or other training category.

As shown in FIG. 13, the employee training status interface 1300 may include an employee name column 1305. The employee name column 1305 may identify individual users associated with the entity and/or users assigned to one or more relevant locations, tasks, job types, and/or training types. In various embodiments, each employee listed in the employee name column 1305 may be associated with one or more corresponding training records displayed within the employee training status interface 1300.

The employee training status interface 1300 may further include a training column 1310. The training column 1310 may identify one or more training modules, training subjects, certifications, quizzes, and/or other training requirements associated with a given employee. In various embodiments, the training column 1310 may list trainings assigned based on a user profile, job title, assigned task, assigned location, entity requirements, regulatory requirements, and/or previously determined training types. As such, the employee training status interface 1300 may allow an authorized user to review which specific training items have been assigned to, completed by, and/or remain outstanding for each employee.

In various embodiments, the employee training status interface 1300 may also include a training status column 1315. The training status column 1315 may present a status associated with each listed training item. For example, the training status column 1315 may include one or more visual indicators, such as badges, icons, text labels, color-coded fields, and/or the like, that indicate whether a training item has been completed, is pending, is overdue, has been failed, and/or otherwise requires attention. The training status may be determined based on verification of completion of the associated training module, such as completion of training materials, completion of a knowledge verification quiz, user verification, visual verification, and/or any combination thereof.

As further shown in FIG. 13, the employee training status interface 1300 may include a last attempted column 1320. The last attempted column 1320 may indicate a date and/or time corresponding to a most recent attempt, access event, completion event, and/or verification event associated with the corresponding training item. In various embodiments, the information within the last attempted column 1320 may be used by an administrator to monitor recency of employee engagement with assigned training materials and identify employees requiring follow-up, reassignment, retraining, and/or escalation.

In various embodiments, the employee training status interface of FIG. 13 may be used as part of generating a training compliance report, monitoring completion across multiple users, and/or determining whether a user is eligible to perform a task, access a location, receive a certification, or otherwise satisfy a training requirement. The employee training status interface 1300 may therefore provide a consolidated administrative view of training progress across a plurality of employees and associated training items within the platform.

Referring now to FIGS. 14A and 14B, the user interfaces during taking and completing a knowledge verification quiz are provided. The user interface 1400 illustrates a knowledge verification quiz that includes two questions. The questions (e.g., first question 1405 and second question 1410) are each multiple choice questions. As discussed herein, any number of different question types may be contemplated (e.g., multiple choice, true/false, open-ended, and/or the like).

In various embodiments, the user interface 1400 may present the knowledge verification quiz after a corresponding training material has been accessed through the platform. For example, the knowledge verification quiz may be made available upon verifying that a user has completed access to an associated training video, reviewed an associated document, and/or otherwise engaged with a training material from beginning to end. In various embodiments, access to the knowledge verification quiz may therefore depend on completion of one or more prerequisite actions associated with the training module.

In various embodiments, each question presented through the user interface 1400 may correspond to one or more concepts, procedures, requirements, and/or other subject matter presented in the associated training materials. The first question 1405 and second question 1410 are shown as multiple choice questions; however, any number of different question types may be used, including true/false questions, open-ended questions, matching questions, fill-in-the-blank questions, and/or the like. In various embodiments, one or more questions may be weighted differently such that different questions contribute different score values to an overall quiz result.

In various embodiments, the user may provide answers to the displayed questions through one or more user inputs received via the computing device associated with the user. Upon completion of the knowledge verification quiz, the user may engage the submit quiz icon 1415 to cause the platform to evaluate the submitted answers. The system may then determine a score for the knowledge verification quiz based on the correctness of the submitted responses, one or more weighting rules, and/or a predefined scoring model associated with the knowledge verification quiz.

In various embodiments, the system may compare the determined quiz score to a passing score threshold to determine whether the knowledge verification quiz has been successfully completed. The passing score threshold may be a default threshold and/or a customized threshold established during creation of the knowledge verification quiz. For example, certain knowledge verification quizzes may require that all questions be answered correctly, while other knowledge verification quizzes may permit successful completion based on a lesser number or percentage of correct answers.

In various embodiments, the platform may determine that a user has not successfully completed a knowledge verification quiz, has not satisfied an engagement requirement associated with a training material, and/or has not satisfied a user verification requirement associated with a training module. In such instances, the system may determine that completion of the training module has not been verified and may maintain the corresponding training status as incomplete, pending, failed, and/or otherwise unresolved.

In various embodiments, in response to determining that completion of a training module has not been verified, the system may cause one or more remedial actions to occur. For example, the system may require the user to repeat access to the training material, retake the knowledge verification quiz, review one or more supplemental training materials, wait a predefined period before another attempt, and/or receive an updated assignment of the same or a related training module. In various embodiments, the system may also generate a notification to an administrator, supervisor, manager, and/or other authorized user indicating that the user has not yet satisfied the training requirement.

In various embodiments, the system may track one or more attempts associated with a training module and may store attempt-related information for later review. For example, the system may store an indication of a number of quiz attempts, a number of failed attempts, a most recent attempt time, one or more scores, and/or an indication of whether a user failed due to knowledge verification, lack of engagement, and/or failed user verification. Such information may be used in connection with compliance reporting, retraining decisions, and/or administrative oversight.

In various embodiments, successful completion of the knowledge verification quiz through the user interface 1400 may be used as part of verifying completion of the corresponding training module. For example, completion of the knowledge verification quiz may be required together with one or more other verification techniques, such as monitoring engagement with the training materials and/or visual verification of the user. As such, the user interface 1400 may form part of a multi-factor training completion verification process implemented by the platform.

Upon completion of the knowledge verification quiz (e.g., via engagement of the submit quiz icon 1415), the user interface 1400 of FIG. 14B illustrates an example notification 1420 of quiz performance. For example, the user passed the quiz with a score of 20 out of 20. The score may be weighted (e.g., different questions may be worth more than other questions). The “passing” determination may be based on a passing score threshold. For example, passing may require all questions to be correct, and/or any other number of questions correct. in various embodiments, the passing score threshold may be a default value and/or customized (e.g., an administrator may require a certain passing score threshold upon creation of the knowledge verification quiz).

In various embodiments, the notification 1420 shown in FIG. 14B may be presented in response to determining that the user has satisfied the passing score threshold for the knowledge verification quiz. The notification 1420 may indicate a score, a passing status, a completion message, and/or other information relating to the user’s performance on the knowledge verification quiz. In various embodiments, a different notification may be provided in an instance in which the user does not satisfy the passing score threshold.

In various embodiments, upon determining that the user has successfully completed the knowledge verification quiz, the system may update a training record associated with the user to indicate completion of the corresponding training module. For example, the system may update a training status associated with the user profile, a location-specific training record, a task-specific training record, and/or a training compliance report to indicate that the user has completed the relevant training requirement. In this regard, the result shown in FIG. 14B may be used not only for user feedback, but also for maintaining administrative compliance records within the platform.

In various embodiments, successful completion of the knowledge verification quiz may cause one or more additional actions to occur within the platform. For example, the system may enable access to one or more additional portions of the platform, permit the user to proceed to a task checklist, indicate that the user is eligible to perform work at a location, generate a completion confirmation, generate a certification, and/or transmit a notification to one or more authorized users. In some embodiments, the completion information may also be stored for later review and reporting.

In various embodiments, the completion information associated with the knowledge verification quiz may be made available to one or more authorized users, such as administrators, supervisors, managers, customer contacts, human resources personnel, and/or other users having appropriate permissions within the platform. For example, the score, passing status, completion state, and/or time of completion may be reflected in one or more employee training status interfaces, location-specific training views, and/or training compliance reports. As such, the result interface shown in FIG. 14B may support both user-facing confirmation and broader administrative oversight.

In various embodiments, the system may also cause a confirmation and/or certification associated with successful completion to be delivered outside of the immediate user interface. For example, the system may transmit an electronic mail message indicating successful completion of the knowledge verification quiz and/or providing a certification relating to the completed training module. The transmitted confirmation may be associated with a particular user, location, task, and/or training type and may be retained as part of the training records for later access.

Referring now to FIG. 15, a flow chart 1500 that details a method of generating and assigning automated training accreditation across remote devices is provided. The method may be carried out by any of the components of the system of FIG. 1. Additionally, the operations may be rendered and/or performed within the platform discussed in reference to FIGS. 4-14B. In various embodiments, the method of FIG. 15 may be carried out using processing device(s), such as processing device(s) within the training data management system 175 and/or the one or more computing device(s) 152. As such, the operations herein may be carried out by any of the embodiments herein unless otherwise stated. Unless otherwise stated, the operations of FIG. 15 may be carried out by the same system, such as the systems of various embodiments discussed herein.

Referring now to optional Block 1510 of FIG. 15, the method includes generating at least one training module. In various embodiments, a training module may include at least one training material (e.g., image, video, document, etc.). The training module may also include one or more knowledge verification quizzes used to confirm completion, as discussed herein. In various embodiments, the at least one training module may be assigned to a training type. The training type may be based on locations (e.g., the location of tasks assigned or potentially assigned to a user), tasks (e.g., tasks assigned and/or potentially assigned to a user), job title (e.g., training based on potential role of user), and/or the like.

In various embodiments, the training modules may be generated (as discussed above in reference to FIGS. 8A-9). The training module may be generated based on receiving training material(s) (e.g., an administrator may upload the training materials). The system may convert the training materials for viewing via the computing device associated with a user. The conversion may include adapting the training material to be displayed via the viewer and/or player software used by the system.

One or more knowledge verification quizzes may be generated based on the training materials. A knowledge verification quiz may be generated manually (e.g., as shown in FIG. 9) and/or automatically (e.g., the system may use artificial intelligence to generate a knowledge verification quiz based on training materials). In various embodiments, the system may process the training material and generate the knowledge verification quiz. For example, the system may use OCR and/or other technology to process a document and generate a knowledge verification quiz based on the contents of the training materials. The training material(s) and associated one or more knowledge verification quizzes may be grouped and/or otherwise associated together as a training module.

In various embodiments, artificial intelligence may be used to assist in generation of one or more portions of a training module. For example, the system may process uploaded training materials to generate one or more suggested quiz questions, answer choices, summaries, transcripts, narrated content, and/or other training-support content associated with the training materials.

In various embodiments, the system may generate audio narration for a document-based training material such that a user may review the training material visually, audibly, and/or in a combined audio-visual manner through the computing device associated with the user. As such, training materials may include videos, documents, narrated documents, images, audio content, and/or combinations thereof.

In various embodiments, AI-assisted generation of quiz content and/or narrated training content may be used to reduce administrative effort associated with creating training modules while maintaining association between the training material and the corresponding knowledge verification content. The resulting AI-assisted content may be reviewed, edited, approved, and/or supplemented by an administrator before assignment to one or more users.

Referring now to optional Block 1520 of FIG. 15, the method includes generating a user profile associated with a user. The user profile may include information relating to the user, such as job title, assigned tasks, past training and/or certifications, and/or the like. The training type of the user may be determined based on the user profile. For example, a user may have a job title that is associated with a given training type (e.g., a janitorial user may be given a janitorial type designation and training modules may be assigned based on the janitorial type designation). The training type, as discussed herein, may be based on the job title, assigned tasks, assigned locations, and/or the like. As such, the user profile may include any of the information discussed herein. The user profile may be used to customize the platform for the user. For example, the tasks assigned to the user may determine the task checklists, the training modules, and/or the like that are provided to the user.

Referring now to Block 1530 of FIG. 15, the method includes determining a training type of a user based on a user profile associated with the user. As discussed above, the training type may be based on the job title, tasks assigned, locations assigned, and/or the like for the user, which may be stored in the user profile. The training type may correspond to the training required for the user. As such, the training modules corresponding to the training type may be assigned to the user. For example, a user assigned to a specific task and/or location may be assigned training module(s) associated with the specific task and/or location. The user may be required to complete the training module(s) assigned before completing the tasks (e.g., the user may not be able to log and/or complete task checklists until the tasks are complete).

In various embodiments, the user may not receive access to a location until the required training module(s) are completed. For example, a location may be access-restricted and the access (e.g., via a card or other access means) may be restricted until the training module is completed. In various embodiments, upon completion of the training module(s), the system may cause the access to be allowed to a location (e.g., the system may be in communication with a device associated with the security access for the location). In various embodiments, the system may cause a transmission of a certification and/or confirmation of the completion of the training module(s) to a third party that may provide access thereafter.

Referring now to Block 1540 of FIG. 15, the method includes determining at least one training module to assign to the user profile based on the training type. As discussed above in reference to Block 1530 of FIG. 15, the training module(s) may be assigned to the user profile (and subsequently the user) based on the training type. The training module(s) may be determined via a training set associated with the training type. In various embodiments, the training type for a user is associated with a training set that includes at least one training modules. The training set may be preset, based on the training type (e.g., a location, task, job title, and/or the like may have a preset training set that are assigned to users). The training set may be customizable (e.g., an administrator may update the training set to add or remove training modules based on the specific user). As such, the training set may be used to assign initial training module(s) and the training set may be updated for the specific user.

Referring now to optional Block 1550 of FIG. 15, the method includes updating the at least one training module for the user based on one or more previously completed training modules. Users may have a variety of previous training that may cause training module(s) to be redundant and/or other unnecessary. As such, the system may determine any training module(s) that are unnecessary for a given user. The training modules may be unnecessary for a user in an instance in which the user has already completed the training module (e.g., different tasks, locations, and/or job titles may share training modules), the user has received equivalent training (e.g., a user may be certified in a certain area and the training module may not be necessary), and/or the like. As such, the system may determine any unnecessary training module(s) for the user and either not assign the unnecessary training module(s) and/or remove the unnecessary training module(s) from the user assignments.

The ability to remove unnecessary training modules allows training to be dynamic and scalable. Electronically training across a large number of users creates efficiency issues. The ability to tailor the training module assignment streamlines the process and also reduces the amount of computing power required. As the training system scales to larger number of users, the amount of processing usage also increases, and the present disclosure provides a solution to the processing usage issues.

Referring now to Block 1560 of FIG. 15, the method includes causing a rendering of a user interface that includes the at least one training module to a computing device associated with the user. Example user interfaces of a platform are shown in FIGS. 4-14B. Example user interfaces that render portions of training modules are shown in FIGS. 12-14B. As discussed herein, the training module(s) may be rendered as part of a platform. The platform may include additional non-training information and/or logging, as discussed herein.

Referring now to Block 1570 of FIG. 15, the method includes verifying completion of the at least one training module. The verification of training module completion may be achieved using knowledge verification (e.g., knowledge verification quizzes), activity monitoring (e.g., monitoring scrolling and/or other activity of a computing device associated with a user), visual confirmation (e.g., a camera part of or otherwise connected to the computing device associated with the user may record an image and/or video of the user completing the training module), and/or the like. Activity monitoring and/or visual confirmation may be referred to as user verification (e.g., verifying the actions of the user).

As discussed herein, the verification of training module completion may include knowledge verification. The knowledge verification may include any of the knowledge verification quizzes discussed herein. The knowledge verification quizzes may be administered during access to the training materials (e.g., question(s) may be asked during a video), at intervals during access to the training materials (e.g., the training material may be segmented, and question(s) may be asked between segments), and/or after access to the training materials (e.g., the question(s) may be asked after a video is played from start to finish and/or a document is scrolled from beginning to end). As discussed herein, a knowledge verification quiz may be available based on completion and/or partial completion of the training module (e.g., the knowledge verification quiz may be available during the access to the training, during portions of the training materials, and/or upon completion of accessing the training materials).

In various embodiments, multiple different methods of verification may be used to increase security. For example, activity monitoring and knowledge verification may be used together by requiring a user to scroll from beginning to end of a document and requiring completion of a knowledge verification quiz. Generally, the system provides verification that the training material(s) were accessed from start to finish (e.g., from beginning to end of a document and/or video). Any number of verification methods may be used alone or in combination. For example, a camera may capture a user during access to the training module(s) and/or taking a knowledge verification quiz and verify that the user is actually the person taking the training.

In various embodiments, the system may use an image and/or video to verify completion of the training module(s). The system may compare the image and/or video to a known image and/or video of the user using facial recognition software. The system may determine whether the user actually took the training based on the comparison. As such, the system may allow for the automated identification. In various embodiments, the image and/or video of the user may be manually inspected and/or stored for future manual inspection (e.g., to ensure compliance with any necessary certifications).

In various embodiments, the system may compare one or more images and/or videos captured during access to a training module with one or more reference images associated with the user profile. For example, the reference images may include a profile image, an onboarding image, a previously captured verification image, and/or other stored visual information associated with the user. Based on the comparison, the system may determine whether the individual accessing the training module corresponds to the intended user.

In various embodiments, visual verification may occur at one or more different times during access to the training module. For example, the system may capture an image and/or video at a beginning of a training session, during presentation of a training material, during completion of a knowledge verification quiz, at a completion event, and/or at multiple intervals throughout the training session. In this regard, the system may determine not only whether the intended user initiated the training module, but also whether the intended user remained associated with the training session during completion of the training module.

In various embodiments, the system may use visual verification together with one or more additional authentication techniques, such as login credentials, device association, session monitoring, and/or engagement monitoring, to determine whether completion of the training module is attributable to the intended user. As such, user identity verification may be implemented as a single-factor or multi-factor verification process within the platform.

Training compliance report(s) and/or certifications may be issued upon completion of the training module(s). In various embodiments, the training compliance report may indicate any training module(s) completed by the user and/or any training sets associated with a training type completed by the user. For example, a training compliance report may indicate training module(s) completed by the user and/or tasks, locations, and/or job titles for which the user is eligible (e.g., the tasks, locations, and/or job titles for which the user is trained). The training compliance report may be isolated to certain training module(s) completed by a user (e.g., only relevant training module(s) may be represented on the training compliance report). In various embodiments, the training compliance report may indicate any outstanding training module(s) assigned to the user (e.g., any training module(s) that have not been completed by the user).

In various embodiments, the system may store one or more verification records associated with completion of a training module. Such verification records may include, for example, a user identifier, a training module identifier, a training material identifier, a location identifier, a task identifier, a training type identifier, a date and/or time of access, a date and/or time of completion, a knowledge verification score, an attempt count, and/or an indication of whether knowledge verification, engagement monitoring, visual verification, and/or other verification techniques were satisfied.

In various embodiments, the system may further store session-related and/or device-related information associated with a training attempt. For example, the system may store a computing device identifier, a network session identifier, a module version identifier, a quiz version identifier, one or more timestamps associated with playback or document review, and/or metadata associated with one or more images or videos captured during user verification. Such information may be retained as part of an audit trail for later review, reporting, and/or compliance validation.

In various embodiments, the stored verification records may be used to support one or more compliance reports, certifications, administrative reviews, customer-facing status views, and/or dispute-resolution processes relating to whether a user completed a particular training requirement. As such, the system may maintain both a user-facing completion state and a deeper audit record associated with the training completion event.

The training compliance report(s) may be associated with a single user and/or multiple users. For example, a user may receive a training compliance report specifically targeted to the user, while a supervisor may receive a training compliance report for multiple users for which the supervisor supervises. The training compliance report(s) may be generated on-demand (e.g., upon request from a user) and/or periodically (e.g., daily, weekly, monthly, etc.). The training compliance report(s) may be provided via the platform and/or off of the platform (e.g., the training compliance report(s) may be delivered via electronic mail and/or other delivery methods).

The training compliance report(s) may include and/or be formatted as a certification. For example, a user may complete the requisite training modules to receive a certification, and the certification may be generated and/or the training compliance report(s) may indicate that the certification has been received. The system may also communicate with third-party entities to receive certification based on completion of training module(s). For example, an association may grant a certification upon completion of certain training for which the training module(s) qualify, and the system may communicate with the association for the user to receive the certification. In such an example, the system may communicate with computing device(s) associated with the third-party and/or other cause transmission of confirmation to the third-party entity.

Referring now to optional Block 1580 of FIG. 15, the method includes assigning a new training module to the user based on the training type of the user. The system may be dynamically updated to maintain training levels for users. In various embodiments, training module(s) may be updated, replaced, and/or added and users may be required to take or retake such training module(s). For example, training requirements for a location, task, and/or job title may change over time and the system allows for training modules to be assigned to update the training as needed. In various embodiments, the system may determine a new or updated training module (e.g., newly created and/or newly assigned to training type). The system may determine whether the user has taken the new or updated training module and assign the new or updated training module in an instance in which the user has not taken the new or updated training module. As such, new training module(s) may be assigned to training type(s) and/or user(s) upon creation.

In various embodiments, a new or updated training module may correspond to a revised version of a previously assigned training module. For example, an entity may revise a training video, instructional document, knowledge verification quiz, and/or other training material to reflect a changed policy, customer-specific procedure, regulatory requirement, safety requirement, equipment requirement, and/or location-specific instruction. In such instances, the system may determine that one or more users who previously completed an earlier version of the training module are to be assigned the revised version of the training module.

In various embodiments, the system may determine whether retraining and/or recertification is to be required based on a version change, a time interval, an expiration rule, a location reassignment, a task reassignment, and/or another triggering condition associated with the user profile or training type. For example, a user may be required to retake a training module after expiration of a certification period, after reassignment to a new location, or after revision of a location-specific training requirement.

In various embodiments, the system may distinguish between a user that has completed a prior version of a training module and a user that has completed a current version of the training module. Accordingly, training compliance may be tracked not only at the level of whether training was completed, but also at the level of whether the user completed a most current training requirement applicable to the user.

The training module(s) assigned to a user may also be updated based on changes to the user profile. For example, a user may be assigned new locations, new tasks, have job title and/or responsibilities change, and/or the like that require different training. As such, the system determines any changes to the user profile and determine any training modules that may be necessary for the user to complete. For example, a user may receive a promotion in which the user is now supervising other users and training module(s) relating to supervising others may be assigned to the user.

In various embodiments, one or more blocks of the flow chart 1500 may be optional, may be performed in a different order, and/or may be performed in combination with one another. For example, generating the at least one training module at Block 1510, generating the user profile at Block 1520, updating the at least one training module at Block 1550, and assigning a new training module at Block 1580 may each be performed in response to different triggering events within the platform and need not occur in the exact sequence illustrated in FIG. 15.

In various embodiments, the flow chart 1500 may be performed on behalf of a single user or across a plurality of users associated with one or more entities, locations, tasks, and/or training types. For example, Blocks 1530-1570 may be performed repeatedly for different users based on differences in user profiles, assigned work, prior completion information, and changing training requirements. As such, the method of FIG. 15 may support scalable assignment and verification of training across a distributed workforce using remote devices.

In various embodiments, the results of the operations shown in the flow chart 1500 may be used to update user eligibility, generate training compliance reports, store completion records, and/or cause certifications, confirmations, or notifications to be provided through the platform or outside of the platform. Accordingly, the flow chart 1500 may represent not only assignment and completion of training modules, but also downstream administrative and compliance functionality associated with verified training completion.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims. Additionally, any number of systems and/or computer program products including at least one non-transitory computer-readable medium having one or more computer-readable program code portion embodied therein may be contemplated to carry out the operations and/or methods discussed herein.

### III. Claim Clauses

Clause 1. A system for generating and assigning automated training accreditation across remote devices, the system comprising: at least one non-transitory storage device; and at least one processing device coupled to the at least one non-transitory storage device, wherein the at least one processing device is configured to: determine a training type of a user based on a user profile associated with the user, wherein the training type indicates a type of training to be assigned to the user; determine at least one training module to assign to the user profile based on the training type; cause a rendering of a user interface that includes the at least one training module to a computing device associated with the user; and verify completion of the at least one training module, wherein the completion of the at least one training module is verified using knowledge verification, wherein the knowledge verification comprises completing a knowledge verification quiz relating to the at least one training module.
Clause 2. The system of Clause 1, wherein the training type is based on a job type for the user.
Clause 3. The system of Clause 1, wherein the at least one processing device is further configured to generate the user profile associated with the user, wherein the user profile indicates the training type for the user.
Clause 4. The system of Clause 1, wherein the at least one processing device is further configured to verify completion of the at least one training module via a user verification, wherein the user verification comprises monitoring the computing device associated with the user for engagement with the at least one training module.
Clause 5. The system of Clause 4, wherein the user verification is completed via monitoring a user input relating to the at least one training module.
Clause 6. The system of Clause 4, wherein the user verification is completed via visual verification using a camera connected to the computing device associated with the user.
Clause 7. The system of Clause 6, wherein the user verification comprises receiving at least one of a picture or a video of the user completing the at least one training module.
Clause 8. The system of Clause 7, wherein the at least one processing device is further configured to verify the user completed the at least one training module based on the at least one of the picture or the video of the user completing the at least one training module.
Clause 9. The system of Clause 1, wherein the at least one processing device is further configured to generate the at least one training module, wherein the at least one training module is assigned to a training type.
Clause 10. The system of Clause 9, wherein generating the at least one training module comprises converting a training material for viewing via the computing device associated with the user.
Clause 11. The system of Clause 9, wherein generating the at least one training module comprises generating the knowledge verification quiz for each of the at least one training module.
Clause 12. The system of Clause 1, wherein each training type is associated with a training set, wherein the training set comprises the at least one training module to assign to the user based on the training type.
Clause 13. The system of Clause 12, wherein the at least one processing device is further configured to update the training set for the user based on one or more previously completed training modules, wherein the one or more previously completed training modules are removed from the at least one training module assigned to the user.
Clause 14. The system of Clause 1, wherein the user interface is rendered as a platform for a user to engage via the computing device associated with the user.
Clause 15. The system of Clause 1, wherein the at least one training module comprises at least one video, wherein the at least one video must be viewed from a start to a finish to verify completion of the at least one training module.
Clause 16. The system of Clause 15, wherein the knowledge verification quiz is available to complete upon completion of the at least one video.
Clause 17. The system of Clause 1, wherein the at least one processing device is further configured to generate a training compliance report, wherein the training compliance report indicates a completion status for each of the at least one training module.
Clause 18. The system of Clause 17, wherein the training compliance report relates to the user and at least one additional user.
Clause 19. The system of Clause 1, wherein the at least one processing device is further configured to cause a certification to be provided to the user based on the completion of the at least one training module.
Clause 20. The system of Clause 1, wherein the at least one processing device is further configured to assign a new training module to the user based on the training type of the user; wherein the new training module is assigned upon creation and association with the training type.
Clause 21. A method of generating and assigning automated training accreditation across remote devices, the method comprising: determining a training type of a user based on a user profile associated with the user, wherein the training type indicates a type of training to be assigned to the user; determining at least one training module to assign to the user profile based on the training type; causing a rendering of a user interface that includes the at least one training module to a computing device associated with the user; and verifying completion of the at least one training module, wherein the completion of the at least one training module is verified using knowledge verification, wherein the knowledge verification comprises completing a knowledge verification quiz relating to the at least one training module.
Clause 22. The method of Clause 21, wherein the training type is based on a job type for the user.
Clause 23. The method of Clause 21, further comprising generating the user profile associated with the user, wherein the user profile indicates the training type for the user.
Clause 24. The method of Clause 21, further comprising verifying completion of the at least one training module via a user verification, wherein the user verification comprises monitoring the computing device associated with the user for engagement with the at least one training module.
Clause 25. The method of Clause 24, wherein the user verification is completed via monitoring a user input relating to the at least one training module.
Clause 26. The method of Clause 24, wherein the user verification is completed via visual verification using a camera connected to the computing device associated with the user.
Clause 27. The method of Clause 26, wherein the user verification comprises receiving at least one of a picture or a video of the user completing the at least one training module.
Clause 28. The method of Clause 27, further comprising verifying the user completed the at least one training module based on the at least one of the picture or the video of the user completing the at least one training module.
Clause 29. The method of Clause 21, further comprising generating the at least one training module, wherein the at least one training module is assigned to a training type.
Clause 30. The method of Clause 29, wherein generating the at least one training module comprises converting a training material for viewing via the computing device associated with the user.
Clause 31. The method of Clause 29, wherein generating the at least one training module comprises generating the knowledge verification quiz for each of the at least one training module.
Clause 32. The method of Clause 21, wherein each training type is associated with a training set, wherein the training set comprises the at least one training module to assign to the user based on the training type.
Clause 33. The method of Clause 32, further comprising updating the training set for the user based on one or more previously completed training modules, wherein the one or more previously completed training modules are removed from the at least one training module assigned to the user.
Clause 34. The method of Clause 21, wherein the user interface is rendered as a platform for a user to engage via the computing device associated with the user.
Clause 35. The method of Clause 21, wherein the at least one training module comprises at least one video, wherein the at least one video must be viewed from a start to a finish to verify completion of the at least one training module.
Clause 36. The method of Clause 35, wherein the knowledge verification quiz is available to complete upon completion of the at least one video.
Clause 37. The method of Clause 21, further comprising generating a training compliance report, wherein the training compliance report indicates a completion status for each of the at least one training module.
Clause 38. The method of Clause 37, wherein the training compliance report relates to the user and at least one additional user.
Clause 39. The method of Clause 21, further comprising causing a certification to be provided to the user based on the completion of the at least one training module.
Clause 40. The method of Clause 21, further comprising assigning a new training module to the user based on the training type of the user; wherein the new training module is assigned upon creation and association with the training type.
Clause 41. A computer program product for generating and assigning automated training accreditation across remote devices, the computer program product comprising at least one non-transitory computer-readable medium having one or more computer-readable program code portions embodied therein, the one or more computer-readable program code portions comprising at least one executable portion configured to: determine a training type of a user based on a user profile associated with the user, wherein the training type indicates a type of training to be assigned to the user; determine at least one training module to assign to the user profile based on the training type; cause a rendering of a user interface that includes the at least one training module to a computing device associated with the user; and verify completion of the at least one training module, wherein the completion of the at least one training module is verified using knowledge verification, wherein the knowledge verification comprises completing a knowledge verification quiz relating to the at least one training module.
Clause 42. The computer program product of Clause 41, wherein the training type is based on a job type for the user.
Clause 43. The computer program product of Clause 41, wherein the at least one executable portion is further configured to generate the user profile associated with the user, wherein the user profile indicates the training type for the user.
Clause 44. The computer program product of Clause 41, wherein the at least one executable portion is further configured to verify completion of the at least one training module via a user verification, wherein the user verification comprises monitoring the computing device associated with the user for engagement with the at least one training module.
Clause 45. The computer program product of Clause 44, wherein the user verification is completed via monitoring a user input relating to the at least one training module.
Clause 46. The computer program product of Clause 44, wherein the user verification is completed via visual verification using a camera connected to the computing device associated with the user.
Clause 47. The computer program product of Clause 46, wherein the user verification comprises receiving at least one of a picture or a video of the user completing the at least one training module.
Clause 48. The computer program product of Clause 47, wherein the at least one executable portion is further configured to verify the user completed the at least one training module based on the at least one of the picture or the video of the user completing the at least one training module.
Clause 49. The computer program product of Clause 41, wherein the at least one executable portion is further configured to generate the at least one training module, wherein the at least one training module is assigned to a training type.
Clause 50. The computer program product of Clause 49, wherein generating the at least one training module comprises converting a training material for viewing via the computing device associated with the user.
Clause 51. The computer program product of Clause 49, wherein generating the at least one training module comprises generating the knowledge verification quiz for each of the at least one training module.
Clause 52. The computer program product of Clause 41, wherein each training type is associated with a training set, wherein the training set comprises the at least one training module to assign to the user based on the training type.
Clause 53. The computer program product of Clause 52, wherein the at least one executable portion is further configured to update the training set for the user based on one or more previously completed training modules, wherein the one or more previously completed training modules are removed from the at least one training module assigned to the user.
Clause 54. The computer program product of Clause 41, wherein the user interface is rendered as a platform for a user to engage via the computing device associated with the user.
Clause 55. The computer program product of Clause 41, wherein the at least one training module comprises at least one video, wherein the at least one video must be viewed from a start to a finish to verify completion of the at least one training module.
Clause 56. The computer program product of Clause 55, wherein the knowledge verification quiz is available to complete upon completion of the at least one video.
Clause 57. The computer program product of Clause 41, wherein the at least one executable portion is further configured to generate a training compliance report, wherein the training compliance report indicates a completion status for each of the at least one training module.
Clause 58. The computer program product of Clause 57, wherein the training compliance report relates to the user and at least one additional user.
Clause 59. The computer program product of Clause 41, wherein the at least one executable portion is further configured to cause a certification to be provided to the user based on the completion of the at least one training module.
Clause 60. The computer program product of Clause 41, wherein the at least one executable portion is further configured to assign a new training module to the user based on the training type of the user; wherein the new training module is assigned upon creation and association with the training type.

1. A system for generating and assigning automated training accreditation across remote devices, the system comprising:
at least one non-transitory storage device; and
at least one processing device coupled to the at least one non-transitory storage device, wherein the at least one processing device is configured to:
determine a training type of a user based on a user profile associated with the user, wherein the training type indicates a type of training to be assigned to the user;
determine at least one training module to assign to the user profile based on the training type;
cause a rendering of a user interface that includes the at least one training module to a computing device associated with the user; and
verify completion of the at least one training module, wherein the completion of the at least one training module is verified using knowledge verification, wherein the knowledge verification comprises completing a knowledge verification quiz relating to the at least one training module.

2. The system of claim 1, wherein the at least one processing device is further configured to verify completion of the at least one training module via a user verification, wherein the user verification comprises monitoring the computing device associated with the user for engagement with the at least one training module.

3. The system of claim 2, wherein the user verification is completed via visual verification using a camera connected to the computing device associated with the user.

4. The system of claim 3, wherein the user verification comprises receiving at least one of a picture or a video of the user completing the at least one training module.

5. The system of claim 4, wherein the at least one processing device is further configured to verify the user completed the at least one training module based on the at least one of the picture or the video of the user completing the at least one training module.

6. The system of claim 1, wherein each training type is associated with a training set, wherein the training set comprises the at least one training module to assign to the user based on the training type.

7. The system of claim 6, wherein the at least one processing device is further configured to update the training set for the user based on one or more previously completed training modules, wherein the one or more previously completed training modules are removed from the at least one training module assigned to the user.

8. The system of claim 1, wherein the at least one training module comprises at least one video, wherein the at least one video must be viewed from a start to a finish to verify completion of the at least one training module.

9. The system of claim 8, wherein the knowledge verification quiz is available to complete upon completion of the at least one video.

10. The system of claim 1, wherein the at least one processing device is further configured to assign a new training module to the user based on the training type of the user; wherein the new training module is assigned upon creation and association with the training type.

11. A method of generating and assigning automated training accreditation across remote devices, the method comprising:
determining a training type of a user based on a user profile associated with the user, wherein the training type indicates a type of training to be assigned to the user;
determining at least one training module to assign to the user profile based on the training type;
causing a rendering of a user interface that includes the at least one training module to a computing device associated with the user; and
verifying completion of the at least one training module, wherein the completion of the at least one training module is verified using knowledge verification, wherein the knowledge verification comprises completing a knowledge verification quiz relating to the at least one training module.

12. The method of claim 11, further comprising verifying completion of the at least one training module via a user verification, wherein the user verification comprises monitoring the computing device associated with the user for engagement with the at least one training module.

13. The method of claim 12, wherein the user verification is completed via visual verification using a camera connected to the computing device associated with the user.

14. The method of claim 11, wherein each training type is associated with a training set, wherein the training set comprises the at least one training module to assign to the user based on the training type.

15. The method of claim 14, further comprising updating the training set for the user based on one or more previously completed training modules, wherein the one or more previously completed training modules are removed from the at least one training module assigned to the user.

16. The method of claim 11, further comprising assigning a new training module to the user based on the training type of the user; wherein the new training module is assigned upon creation and association with the training type.

17. A computer program product for generating and assigning automated training accreditation across remote devices, the computer program product comprising at least one non-transitory computer-readable medium having one or more computer-readable program code portions embodied therein, the one or more computer-readable program code portions comprising at least one executable portion configured to:
determine a training type of a user based on a user profile associated with the user, wherein the training type indicates a type of training to be assigned to the user;
determine at least one training module to assign to the user profile based on the training type;
cause a rendering of a user interface that includes the at least one training module to a computing device associated with the user; and
verify completion of the at least one training module, wherein the completion of the at least one training module is verified using knowledge verification, wherein the knowledge verification comprises completing a knowledge verification quiz relating to the at least one training module.

18. The computer program product of claim 17, wherein the at least one executable portion is further configured to verify completion of the at least one training module via a user verification, wherein the user verification comprises monitoring the computing device associated with the user for engagement with the at least one training module.

19. The computer program product of claim 18, wherein the user verification is completed via visual verification using a camera connected to the computing device associated with the user.

20. The computer program product of claim 17, wherein each training type is associated with a training set, wherein the training set comprises the at least one training module to assign to the user based on the training type.
